(19) United States
(12) Patent Application Publication
(10) Pub. No.: US 2008/0281641 A1
(43) Pub. Date: Nov. 13, 2008

(54) SYSTEM AND METHOD FOR ADMINISTERING A GROUP BENEFIT PLAN

(76) Inventors: Paul Zane Pilzer, Park City, UT (US); David Matthew West, Fremont, CA (US); Thomas James Elgin, Park City, UT (US); Benjamin Norris Dilts, Park City, UT (US); Joshua Benjamin Harris, Easton, MA (US); Tyler Matheny King, Park City, UT (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/101,894

(22) Filed: Apr. 11, 2008

Related U.S. Application Data
(60) Provisional application No. 60/917,617, filed on May 11, 2007.

(51) Int. Cl. G06Q 40/00

(52) U.S. Cl. 705/4

(57) ABSTRACT

A system and method for administering a group benefits plan having a processor configured to receive data for enrolling a participant in a group benefits plan self-administered by an employer, receive a claim submission for the participant, transmit the claim submission to a plan supervisor terminal for review, and receive electronic notification to deny or reimburse the participant's claim submission.

### RELATED APPLICATION

This application claims the benefit of and priority to U.S. Provisional Application Ser. No. 60/917,617; filed May 11, 2007, the contents of which are incorporated by reference herein in its entirety.

### BACKGROUND

This disclosure relates to a group benefit plan and more particularly to a system and method for self-administering a group benefit plan.

### SUMMARY

A system and method for self-administering a group benefits plan having a processor configured to receive data for enrolling a participant in a group benefits plan self-administered by an employer, receive a claim submission for the participant, transmit the claim submission to a plan supervisor terminal for review, and receive electronic notification to deny or reimburse the participant's claim submission.

According to a feature of the present disclosure, the processor may be configured to transmit instructions for reimbursing the participant from an employer's account, receive a benefits plan design criteria for creating a self-administered group benefits plan, receive a list of qualified expenses allowed for reimbursement, automatically generate form documents after receiving a benefits plan design criteria for creating the self-administered group benefits plan, perform claim eligibility analysis prior to transmitting the claim submission for review, perform claim adjustment analysis after receiving electronic notification to deny or reimburse the participant's claim submission, determine if the participant has coinsurance, grant access to a vendor to view a participant's claim submission, integrate an employer's account with the group benefits plan, compute tax liability of the participant for excess reimbursement, and report the tax liability to the participant.

According to a feature of the present disclosure, the group benefits plan may be selected from a group consisting of a Health Savings Account, a Health Reimbursement Arrangement and a Flexible Spending Account. The participant may be selected from a group consisting of an employee, an employee's spouse and an employee's dependent. The employee's spouse and dependent may have separate accounts from the employee to maintain the privacy of their claim submissions.

According to a feature of the present disclosure, a machine-readable medium is disclosed. The machine-readable medium provides instructions, which when read by a processor, cause the machine to perform operations including receiving data for enrolling a participant in a group benefits plan self-administered by an employer, receiving a claim submission for the participant, transmitting the claim submission for review, and receiving electronic notification to deny or reimburse the participant's claim submission.

According to a feature of the present disclosure, a method, machine-readable medium and system for administering a group benefits plan is disclosed. The system having a processor configured to receive a first data for a plurality of participant classes in the group benefits plan, wherein at least one of the plurality of the participant classes having a health benefit coverage different from the others. The at least one of the plurality of the participant classes having a claim eligibility different from the others, and a first dollar coverage different from the others. The processor may further be configured to receive a second data for a participant's status in the group benefits plan, wherein the participant's status is selected from a group consisting of a retired status and a new hire status.

According to a feature of the present disclosure, a method, machine-readable medium and system for administering a defined-contribution benefits plan is disclosed. The system having a processor configured to receive a first data for a participant account in a group benefits plan, retrieve a plan design option for the participant account, retrieve a second data for an allowance amount to be applied to the participant account for reimbursement, and receive a claim submission for the participant account. The processor may further configured to determine reimbursement for the claim submission of a qualified medical expense from the allowance amount and the plan design option.

According to another feature of the present disclosure, a method, machine-readable medium and system for facilitating the delivery of marketing material to participants of a group benefits plan is disclosed. The system having a processor configured to receive data for a participant account in the group benefits plan, the data having a contact information, and grant a third party vendor with limited access to the data for acquiring the contact information for delivery of the marketing material.

According to yet another feature of the present disclosure, a method, machine-readable medium and system for modifying a participant's benefits plan is disclosed. The system having a processor configured to receive an employer's selection of a group benefits plan from a client terminal, the group benefits plan excludes a Health Savings Account, compute at least one option for compatibility with the Health Savings Account, receive data for a participant account in the group benefits plan, transmit the at least one option for compatibility with the Health Savings Account, and receive a participant's election of one of the at least one option to modify the group benefits plan.

In accordance with a feature of the present disclosure, a method, machine-readable medium and system for modifying a participant's benefits plan is disclosed. The system having a processor configured to receive an employer's selection of a group benefits plan from a client terminal, the group benefits plan includes a Health Savings Account (HSA), compute at least one option for modifying the group benefits plan for HSA compatibility, receive data for a participant account in the group benefits plan, transmit the at least one option for modifying the group benefits plan, and receive a participant's election of one of the at least one option to modify the participant's benefits plan for HSA compatibility.

According to another feature of the present disclosure, a method, machine-readable medium and system for administering a benefits plan is disclosed. The system having a processor configured to receive a first data for a participant account in a benefits plan, the benefits plan selected from a group consisting of a Health Reimbursement Arrangement and a Flexible Spending Account, receive a claim submission for the participant account, transmit a query requesting proof of health insurance or proof of uninsurability, receive a second data providing proof of health insurance or proof of uninsurability, and compute reimbursement amount for the claim submission based on the received second data.

According to yet another feature of the present disclosure, a method, machine-readable medium and system for accumulating a dollar allowance in a Health Reimbursement Arrangement is disclosed. The system having a processor configured to receive an employer's selection of a dollar allowance per hour worked, receive data for enrolling an employee in the Health Reimbursement Arrangement, receive a number of hours worked by the employee in a predetermined period, and compute the dollar allowance for the predetermined period to be accumulated, in the employee's Health Reimbursement Arrangement by multiplying the employer's dollar allowance per hour worked with the employee's number of hours worked.

### DRAWINGS

The above-mentioned features and objects of the present disclosure will become more apparent with reference to the following description taken in conjunction with the accompanying drawings wherein like reference numerals denote like elements and in which:

FIG. 1 is a functional block diagram of a computer architecture for a data processing system that utilizes a group benefits plan, according to one embodiment of the invention.

FIG. 2 is a functional block diagram of a network system utilizing a software program for administering and accessing a group benefits plan, according to one embodiment of the invention.

FIGS. 3A-C illustrates a flow diagram of a method for creating a group benefits plan, according to an embodiment of the invention.

FIG. 4 is a flow diagram of a method for enrolling a participant in a group benefits plan, according to an embodiment of the invention.

FIG. 5 is a flow diagram of a method for submitting a claim for reimbursement under the group benefits plan, according to an embodiment of the invention.

FIG. 6 is a flow diagram of a method for reviewing submitted claims under the group benefits plan, according to an embodiment of the invention.

FIG. 7 is a flow diagram of a method for reimbursing participants for approved claims, according to an embodiment of the invention.

FIG. 8 is a flow diagram of a method for periodically adjusting a participant's balance, according to an embodiment of the invention

FIGS. 9-13 are exemplary web pages illustrating features of the plan creation method of FIGS. 3A-3B, according to an embodiment of the invention.

FIG. 14 is an exemplary webpage illustrating the ability to select, examine, and download various of the communications messages generated by the software program of FIG. 2, according to an embodiment of the invention.

FIGS. 15-16 are exemplary web pages illustrating features of the participant enrollment method of FIG. 4, according to an embodiment of the invention.

FIGS. 17-20 are exemplary web pages illustrating features of the claim submission method of FIG. 5, according to an embodiment of the invention.

FIGS. 21-23 are exemplary web pages illustrating features of the claim approval method of FIG. 6, according to an embodiment of the invention.

FIGS. 24-28 are exemplary web pages illustrating features of the reimbursement method of FIG. 7, according to an embodiment of the invention.

FIGS. 29-31 are exemplary web pages illustrating other features of the software program of FIG. 2 utilized by the plan administrator, according to an embodiment of the invention.

FIG. 32 is a flow diagram of a method for self-administering a group benefits plan, according to an embodiment of the invention.

### DETAILED DESCRIPTION

In the description that follows, the present invention will be described in reference to an embodiment that operates on the Internet. In particular, examples will be described which- illustrate particular applications of the invention on the Internet for administering and accessing funds in a Health Reimbursement Arrangement (HRA). The present invention, however, is not limited to any particular information source nor limited by the examples described herein. For example, a Health Savings Account (HSA), a Flexible Spending Account (FSA), or a Health Opportunity Account (HOA) may be implemented with the present invention. Therefore, the description of the embodiments that follow are for purposes of illustration and not limitation.

A Health Savings Account (HSA) is an individual savings account similar to an Individual Retirement Account (IRA). There are annual contribution limits ($2900 for an individual/$5800 for a family in 2008). An employee may contribute to his HSA with after-tax dollars and receive an above-the-line tax deduction at the end of the year; or he may contribute pretax straight from his paycheck, and/or his employer may also contribute tax-free money (all subject to the contribution limits).

An HRA is an arrangement (not an account) by which an employer agrees to reimburse employees tax-free for certain qualified medical expenses. In general, an employer typically agrees to give regular allowances to employees stored in fictional (unfunded) accounts, which may roll forward from year to year, and to reimburse employees for qualified medical expenses not covered by other insurance up to their current HRA balance. An HRA may include a retirement benefit (vesting), but with most HRAs, the employee forfeits any balance when they quit or are terminated. All claims for reimbursement must be substantiated by receipts, and due to the complex regulations and liabilities surrounding privacy of health information, the employer may engage a third party to verify receipts. In practice, HRAs are used either (a) to supplement a group health insurance plan, where the HRA reimburses for medical expenses not covered by the plan, or (b) as a substitute for a group health insurance plan, where employees are encouraged to purchase personal insurance policies of their choice, using the HRA to reimburse premiums for those policies and also any out-of-pocket medical expenses not covered by those policies. Reimbursements through an HRA are generally tax-deductible as expenses (as fringe benefits) by the business and not reported as income (thus, not subject to income tax or withholding) for the employees. An HRA is subject to ERISA, HIPM, COBRA, and other regulations that make it very difficult to administer correctly without the use of the software program of the present invention.

A Flexible Spending Arrangement/Account (FSA) is similar to an HRA in that it is an employer-sponsored plan used to reimburse participants for qualified medical expenses not covered by other insurance. There are a few key differences. First, rather than the employer offering reimbursements on top of the employee's salary, the FSA is funded through deductions from the employee's salary. Second, any amount left over in an FSA at the end of each calendar year is forfeited (no roll-forward). Third, an FSA cannot reimburse for premiums on a personal health insurance policy (this will change in 2009). As such, FSAs are currently only used as supplements to group health plans, not replacements. Fourth, FSAs are much more established, being 30-some years old, tens of millions of employees now have access to an FSA.

In one embodiment, the invention may be used to facilitate the (1) creation and (2) administration of a group benefits plan with or without a benefits professional or third-party administrator. The invention may facilitate reimbursement of participants in the plan of benefits in a relatively short period of time after claim submission. Further, the invention may allow a company to implement the plan of benefits full freedom within the law to customize the plan of benefits for different participants. In addition, the invention may be used to allow the participants in the plan of benefits full freedom within the law to combine this plan with other plans and maintain eligibility in other plans to the extent possible.

Three roles may be defined in relation to the benefits plan. The first role is that of a participant in the plan, who receives benefits from the plan. In one embodiment, the participant could be an employee of the company implementing the plan or a private contractor for the company. The second role is that of plan administrator, who performs the distribution of benefits of the plan to its participants. In one embodiment, the plan administrator may be the employer himself or a third-party administrator. The plan administrator may be denied access to any sensitive data of participants', including protected health information of participants. The third role is that of plan supervisor, who processes claims of the participants, certifying for the administrator which claims are eligible for reimbursement according to the benefit plan. The plan supervisor has access to sensitive data of the participants', including protected health information of participants. In one embodiment, the plan supervisor may be a third party or a HIPPM protected health information designee within the company implementing the plan.

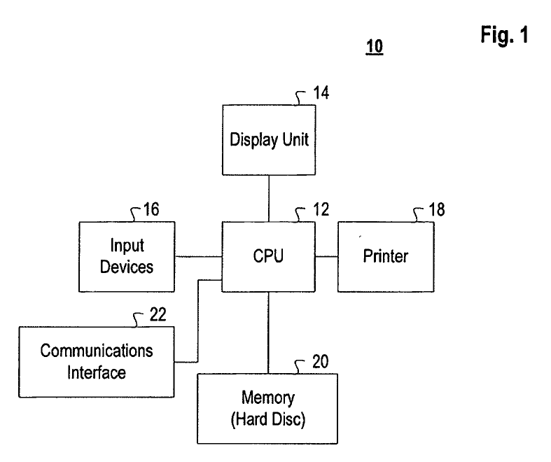

FIG. 1 is a functional block diagram of a computer architecture for a data processing system 10 that utilizes a group benefits plan, according to one embodiment of the invention. The data processing system 10 may be configured to enter and/or process data for a group benefits plan. The data processing system 10 may include a control processing unit (CPU) 12, a data display unit 14, a printer 18, data input devices 16, such as a keyboard and mouse, and a data memory 20. As illustrated in FIG. 1, the CPU 12, such as a processor, may be connected separately with each of the CRT 14, the printer 18, the input devices 16 and the memory 20.

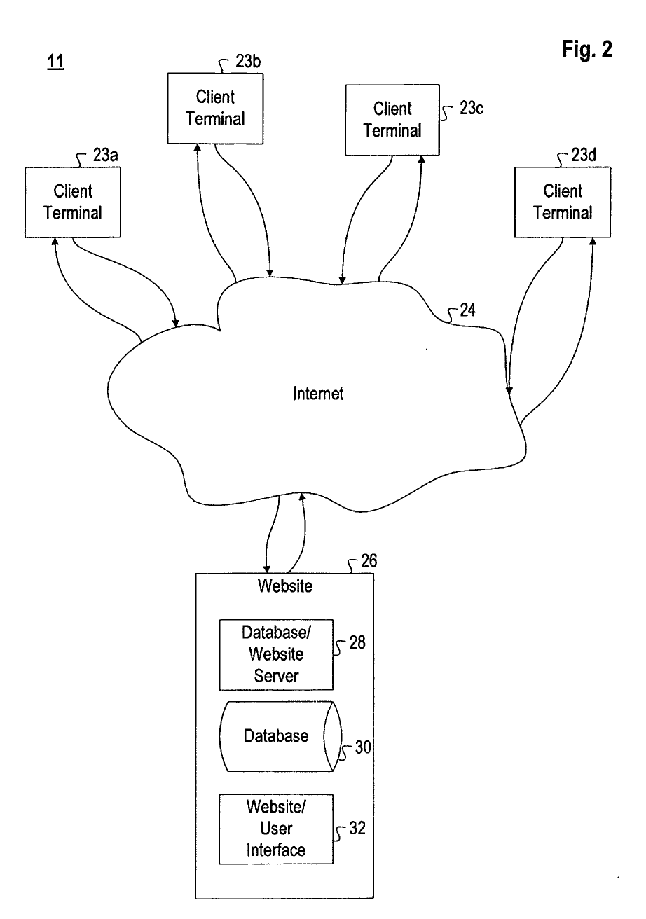

The data processing system 10 may be employed as a client terminal 23 of a network system 11, as shown in FIG. 2. When used in such a system 11, the CPU 12 is coupled to a communications interface 22. In one illustrative embodiment, the interface 22 may be a modem for connecting a client terminal 23 with a network, such as an Internet 24.

As illustrated in FIG. 2, more than one client terminal 23a-d may be coupled to a website 26 via the Internet 24. The Internet 24 provides bidirectional flow of data with the website 26. The website 26 may be integrated with a database/website server 28, a database 30 and a website user interface 32.

The database/website server 28 includes a software program and a processor that permits an individual to log on, review and/or select individual products of his or her group benefits plan and submit claims. This program generates web pages for display on the client terminal 23 to facilitate the selection of the benefit products for the group benefits plan.. The website user interface 32 provides a communication interface between the website 26 and the client terminal 23.

The software program is generally stored in the database 30 and is executed by the database/website server 28. The software program can be implemented using hardware, software or a combination of hardware and software. The database 30 can be referred to as a machine-readable medium, which may be any mechanism that provides (i.e. stores and/or transmits) information in a form readable by the database/website server 28. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. The database 30 may be used to store, arrange and retrieve data. For example, the database 30 may receive and store data related to the individual choices available under the group benefits plan and data related to the processing of an individual's benefit plan.

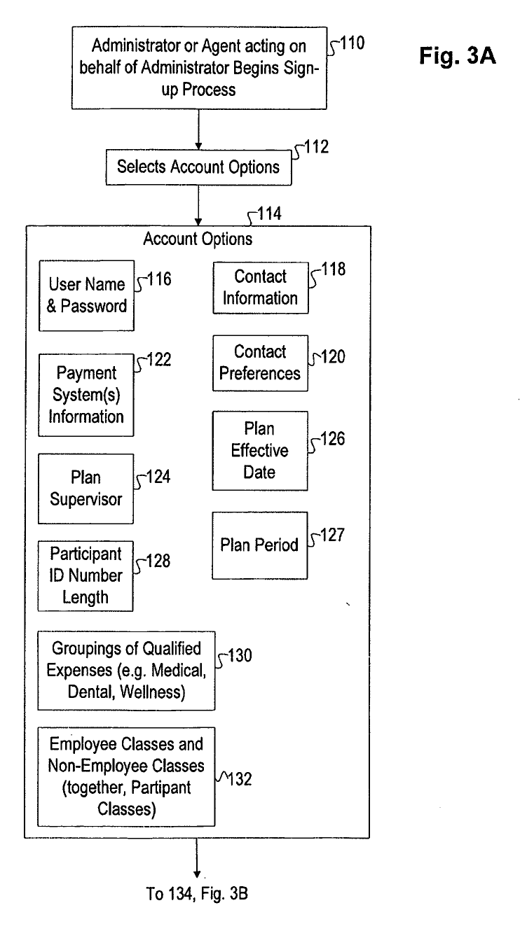

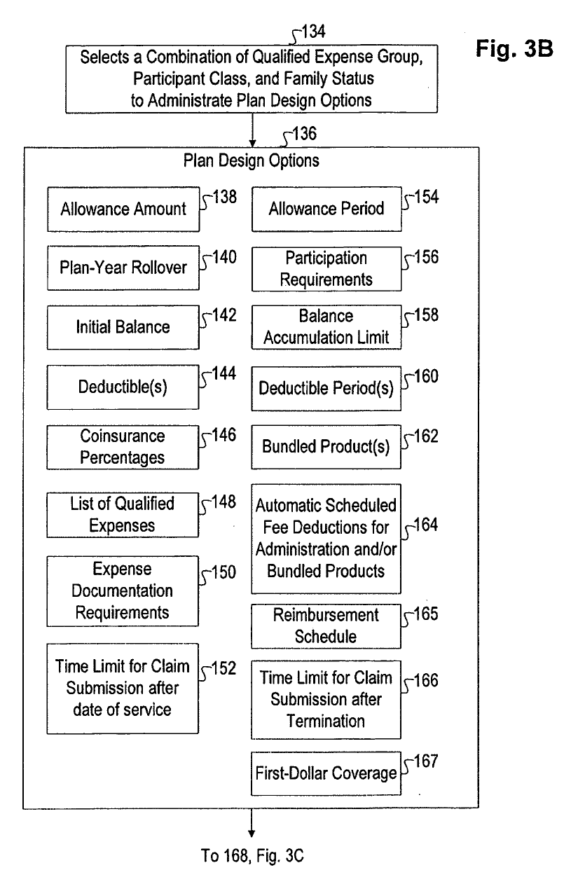

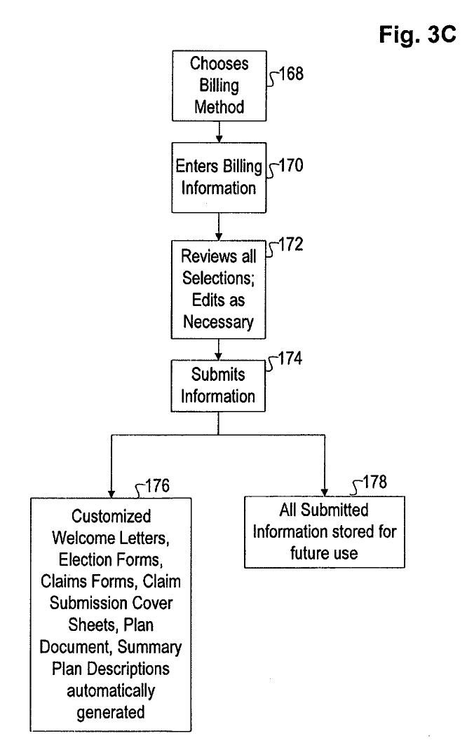

Referring now to FIGS. 3A-C, a flow diagram of a method for creating the group benefits plan is provided, according to an embodiment of the invention. The method may not require the employer to outlay any money for use in reimbursing participants until a participant has a reimbursement due amount above zero (no pre-funding). An administrator, such as an employer creating a self-administered plan, begins the sign-up process 110, in FIG. 3A, by selecting the appropriate account options 112. Account Options 114 are selected in accordance with the employer's goals for the group plan of benefits. The administrator may be prompted to input a user name and password 116, contact information 118, contact preferences 120, payment system information 122, plan supervisor information 124, plan effective date 126, plan period 127, participant ID number length 128, groupings of qualified expenses 130, and employee classes and non-employee classes 132.

The user name and password 116 may be stored in the database 30. The password 116 (and other confidential information) may be encrypted using an irreversible hashing algorithm that allows for future verification of the password 116 without allowing the possibility of retrieving the original password 116 from the hashed version. The contact information 118 may include the name of a person to contact for plan administration functions along with two phone numbers, a fax number, an e-mail address and a mailing address for that individual. The contact preferences 120 may include options for the administrator to receive notification by email, pager, SMS text message, fax, or telephone upon any change to a participant's reimbursement due, daily, weekly, and/or monthly, or no automatic notifications. Payment system information 122 may include information that will be made available to the administrator to utilize in reimbursing participants. In one embodiment, payment systems information 122 includes integration with commonly used payroll administration systems, including those provided by ADP, PayChex, PrimePay, and others; information to process electronic bank transactions such as with Automated Clearing House (ACH); and information to charge a credit card or stored value card. A plan supervisor information 124 includes identification and contact information of a third party service provider, such as Zane Benefits, Inc. or an individual within the employer company that has been designated to have access to participants' information, including health information protected by the Health Insurance Portability and Accountability Act (HIPAA), for example the company's Privacy Official. The plan effective date 126 and plan period 127 are selected in accordance with applicable laws, together defining the plan term. The participant ID number length 128 for the website 26 may be used to set the size of ID numbers used to track participants for better integration with third party software/systems that the employer or administrator may be using.

The groupings of qualified expenses 130 may be selected using predetermined employer-specific criteria under the group benefit plan. The list for a grouping may be stored in a list of qualified expenses 148 for each plan design 136. For example, groupings of qualified expenses 130 may be all expenses allowed for reimbursement in self-insured group plans by current U.S. Code, all expenses that are qualified for coverage or to contribute to the deductible of a specified group health insurance policy or any individual health insurance policy covering the participant, individual health insurance premiums, or any combination thereof or of a countless number of other combinations of allowable qualified expenses.

The employee and non-employee classes 132 selected by the administrator may be derived directly from Employee Classes already defined by the employer. Classes 132 may be constructed to consider the employee's job title, tenure, geographic location, full-time vs part-time status, participation in a collective bargaining agreement, employment status (for example, Active, Suspended, Inactive, COBRA, Retired, or Terminated), choice of other group benefit plan, health factors of the employee or his dependents, or any other criteria as allowed by law. Additional non-employee classes 132 may be defined to allow non-employees who do not participate in the group benefit plan to nonetheless utilize the website 26 for reimbursement of expenses. Non-employee participants may be subject to income tax for benefits received through the website 26 outside of a group benefits plan.

In one embodiment, the administrator may be prompted to select plan options 136, as shown in FIG. 3B. A different set of plan options 136 may be selected for every possible combination of qualified expenses, a participant class, and a family status 134. For example, family status may be “Single,” “Married,” “Single with Children,” and “Married with Children.” A participant's enrolled dependents may be subject to different plan design options than the participant. Each plan design 136 requires specification of a number of parameters. By way of example, the plan design 136 includes parameters, such as allowance amount 138; plan-year rollover 140, initial balance 142, deductible(s) 144, coinsurance percentages 146, list of qualified expenses 148, expense documentation requirements 150, time limit for claim submission after date of service 152, allowance period 154, participation requirements 156 (including verification procedures of such requirements), balance accumulation limit 158, deductible period(s) 160, bundled product(s) 162, automatic scheduled fee deductions 164 and time limit for claim submission after termination or change of status or end of plan year 166. Other parameters include first-dollar coverage amount 167 (amount allowed for reimbursement before applicable deductible(s) or coinsurance take effect), and reimbursement schedule (optional) 165 which may include a specification that no reimbursements will be made to a participant in the given plan design until a status or other change occurs that changes the plan design applicable to the participant. The reimbursement schedule may also specify that certain expenses are eligible to be reimbursed instantly upon approval by an automated payment mechanism.

A balance is maintained for a participant in each plan design 136 applicable to him or her. Applicable plan designs 136 for a participant may be determined by examining the participant's class and family status, and participation requirements 156 of all plan designs. In one embodiment, a participant cannot belong to more than one participant class, nor more than one family status, and so a balance is maintained for each participant for each group of qualified medical expenses for which he/she meets all participation requirements 156. The allowance amount 138 and allowance period 154 determine the accumulation of allowances (defined-contribution benefits) for the balance amount, as explained later in detail.

In one embodiment of the invention, the allowance period may be per hour worked, per month, per quarter, per annum, or another period defined by the administrator. The balance accumulation limit 158, automatic scheduled fee deductions 164, participation requirements 156, and plan-year rollover 140 also affect the balance amount. As can be envisioned by a person skilled in the art, the software program may be programmed to provide instructions to a processor to receive an employer's selection of a dollar allowance per hour worked (per month worked, per quarter worked, etc.), receive data for enrolling an employee in the Health Reimbursement Arrangement, receive a number of hours (or months, quarters, etc.) worked by the employee in a predetermined period, and compute the dollar allowance for the predetermined period to be accumulated in the employee's Health Reimbursement. Arrangement by multiplying the employer's dollar allowance per hour worked (or months, quarters, etc.) with the employee's number of hours worked (or months worked, quarters worked, etc.).

Participation requirements 156 may include minimum hours worked, minimum tenure, and/or a requirement to provide proof of health insurance coverage. To comply with nondiscrimination regulations, a reasonable alternative may be accepted for those unable to qualify for an individual health insurance policy, such as a rejection letter or evidence of uprating from a health insurance carrier. As can be envisioned by a person skilled in the art, the software program may be programmed to provide instructions to a processor to receive a first data for a participant account in a benefits plan, the benefits plan selected from a group consisting of a Health Reimbursement Arrangement and a Flexible Spending Account, receive a claim submission for the participant account, transmit a query requesting proof of health insurance or proof of uninsurability, receive a second data providing proof of health insurance or proof of uninsurability, and compute reimbursement amount for the claim submission based on the received second data.

The plan-year rollover 140 may include options to allow no rollover of balance from one plan year to the next, allow 100% rollovers, allow 100% rollover up to a maximum limit to the amount rolled over, or allow a percentage between 0% and 100% of balance to roll over with no limit or up to a maximum dollar limit. The initial balance 142 determines the initial value of the balance for participants with the plan design 136 upon enrollment. The deductible(s) 144 and deductible period(s) 160 may define an amount of the total value of approved claims for qualified expenses 148 (after using up any applicable first-dollar coverage) that can be submitted by the participant within a given time period before any amounts submitted in the same time period are eligible for reimbursement through the plan. The deductible(s) may apply to all or a subset of the qualified expense types 148 allowed by the plan design. For instance, this may take the form of a single annual deductible, or a single annual deductible that is waived for certain expenses such as preventative care. Coinsurance Percentages 146 may be used to determine the discount percentage that may be applied to a claim amount, and may depend on the specific type of expense for the claim, before reimbursement occurs. For example, maternity and dental expenses may be subject to 50% coinsurance while preventative care expenses are not subject to coinsurance and other expenses are subject to 20% coinsurance. First-dollar coverage 167 may be used to specify maximum total amounts for which claims for each particular type of expense may be reimbursed without applying deductibles 144 or coinsurance 146 during the deductible period 160, or another period. For example, in a plan where a deductible and coinsurance apply to dental expenses, the plan may nonetheless offer 100% reimbursement of a participant's first $200 per year of dental expenses without applying the deductible or coinsurance. In one embodiment, deductibles 144, coinsurance 146, and other reimbursement amount adjustments or restrictions may only be applied to claims for a particular type of expense after the cumulative amount of claims for that type of expense submitted during the applicable period exceeds the first-dollar coverage amount for that type of expense, if any.

Expense documentation requirements 150 may include documents required by the Internal Revenue Code, generally a receipt indicating the nature, provider, date of service, and amount of the expense. In the event that the list of qualified expenses 148 allows for only expenses of types covered by a group or individual health insurance policy, the documentation requirements 150 may include the requirement for an Explanation of Benefits document from the insurance policy carrier. Documentation may be delivered directly from the service provider for review by the plan supervisor, electronically or otherwise. The time limit for claim submission after date of service 152 and time limit for claim submission after termination or change of status or end of plan year 166 may be utilized in limiting eligibility of claims for reimbursement.

Bundled product(s) 162 may include membership in a discount medical, dental or pharmacy program, membership in an association offering accident medical or other benefits, or other products. Participation requirements 156 determine which participants may receive benefits from the plan design 136, and may include requirements to obtain the bundled product(s) 162, while the automatic scheduled fee deductions 164 include any applicable fees for the bundled products 162. In addition to fees for bundled product(s) 162, fees covering administration costs of the group benefit plan may be included in automatic scheduled fee deductions 164.

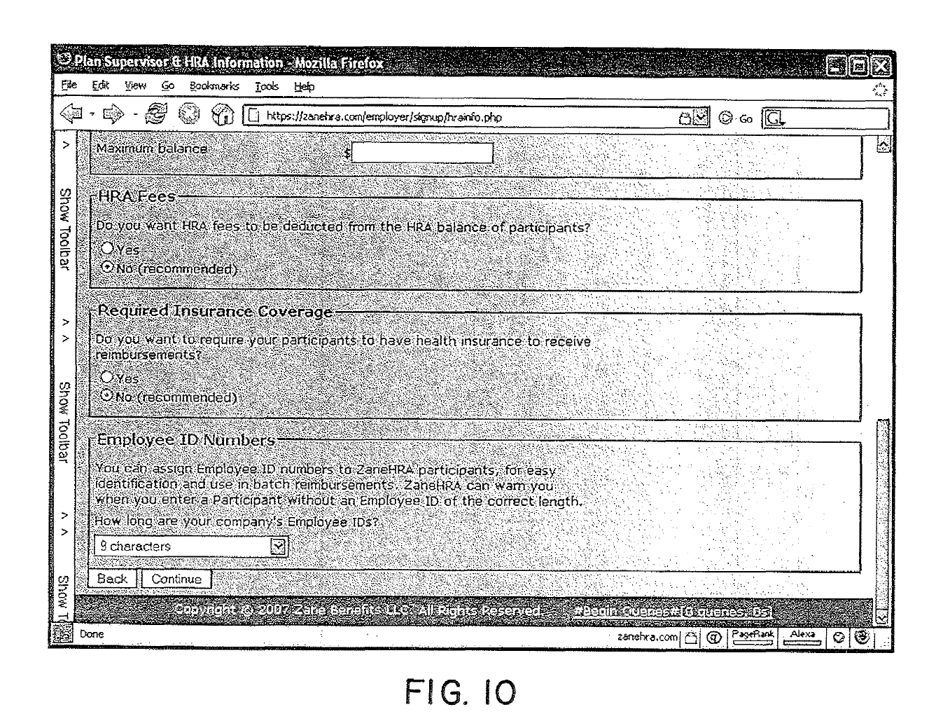

According to an embodiment of the invention, recommended options for selecting plan design 136 are shown as default, and detailed information about many of the options are hidden from view until a non-default selection is made. An example of a recommended option is shown in FIGS. 10-11 regarding the option to require insurance coverage as part of participation requirements 156. According to an embodiment of the invention, after plan design options 136 are selected, the software program may run tests that give warnings in the event that the chosen plan design options 136 are determined to potentially violate anti-discrimination laws according to current applicable code, i.e., Internal Revenue Code, U.S. laws, state laws, etc.

In one embodiment of the invention, different plan design options 136 may be created by the plan administrator or employer in order to meet specific recruiting and retention goals of the employer. One example of such a use would be to create multiple plan designs for a particular class of employee, such as a manager. One plan design would be for “Active Managers” that included a standard benefits package. Another plan design would be for “Newly Hired Managers,” which would apply to all Managers with less than 180 days of tenure, in which allowances would accrue and claims would be processed as normal, but reimbursements would not be made until a change in status (in this case, working for 180 days) triggered a switch to the regular Managers plan design. A third plan design would be for “Retired Managers,” which would apply to all Managers who had retired, in which benefits are similar but new allowances no longer accrue to the participant's HRA Balance. Another application of plan design options would be to provide increased benefits for participants who possess or who have a family member who possesses an adverse health factor. For example, the administrator could designate that all Managers and Secretaries with any of a list of adverse health conditions (e.g. diabetes, heart murmur, cancer, etc.) are eligible to participate in a different plan design that provides 50% larger allowances than they would otherwise receive. Enrollment in this plan design may be accomplished by requiring participants to submit proof of diagnosis with the health factor to the employer's privacy official or to the plan supervisor 124; such proof may be required to be updated once per plan year. As can be envisioned by a person skilled in the art, software program may be programmed to send instructions to a processor to receive data for a participant's status in the group benefits plan, wherein the participant's status is selected from a group consisting of a retired status and a new hire status.

After selecting plan design options 136, the administrator may proceed to select a method of billing 168 by entering billing information 170, as shown in FIG. 3C. Billing methods may include credit card, electronic direct deposit, or monthly or quarterly billing via a delivered statement. This billing information may be used to pay fees associated with the group plan, while the payment systems information 122 may be used to pay reimbursements owed to participants in the plan. In some cases, reimbursements may be paid to the participant and in other cases payment may be made directly to a service provider. The administrator may be prompted to review 172 all selections and entries made in steps 112-170 and change any option individually, or several options simultaneously, while retaining previous selections for all other options. Finally, the administrator submits 174 his selections, which are stored in the database 30 of the website 26 for future use 178.

A feature of the software program is that upon completion of the sign-up process, shown in FIG. 3, necessary documents are automatically generated in accordance with the selections made during the sign-up process 176. In one embodiment, this includes welcome letters, election forms, claim submission forms, documentation submission cover sheets, plan document and summary plan description in accordance with current U.S. Code for the group benefit plan. For example, automating compliance with various regulations for health plans including disclosure requirements, and automated behavior upon a participant's change of status. This may include sending automated notifications to participants eligible for COBRA continuation coverage, automated calculation of COBRA premiums, automated splitting of an account after a divorce/separation, implementation of a vesting schedule for certain plan benefits to remain available after retirement, automated disclosure of changes to the plan (which may be recorded and verified electronically), etc. Furthermore, the software program may automatically create a Plan Document for the plan satisfying relevant regulations to treat the plan as a single plan, while at the same time creating a different Summary Plan Description document for each Employee Class so that multiple plan designs and benefits options are managed under a single group benefit plan for ease of administration.

As can be envisioned by a person skilled in the art, the software program may be programmed to send instructions to a processor to receive a first data for a plurality of participant classes in the group benefits plan, wherein at least one of the plurality of the participant classes having a health benefit coverage different from the others. The at least one of the plurality of the participant classes having a claim eligibility different from the others, and a first dollar coverage different from the others.

In one embodiment, the software program may be configured to maintain a list of participants who have not yet acknowledged receipt of a document such as a Summary Plan Description or signed an election form to participate. Such participants may not be able to have a claim approved or receive benefits from the plan until they complete a required acknowledgment or election form. Whenever one of these participants uses the system by logging in through a client terminal 23 or submitting a claim, they may be notified of the action they need to take and presented with an electronic or paper form to complete. The software program may be configured to print required acknowledgment or election forms, and allow the administrator to certify that certain participants have completed the form or action required. As such, an administrator may change plan design for one or more Classes of Employees at any time, including in the middle of a plan year, and easily ensure compliance with any disclosure requirements that apply to the modification.

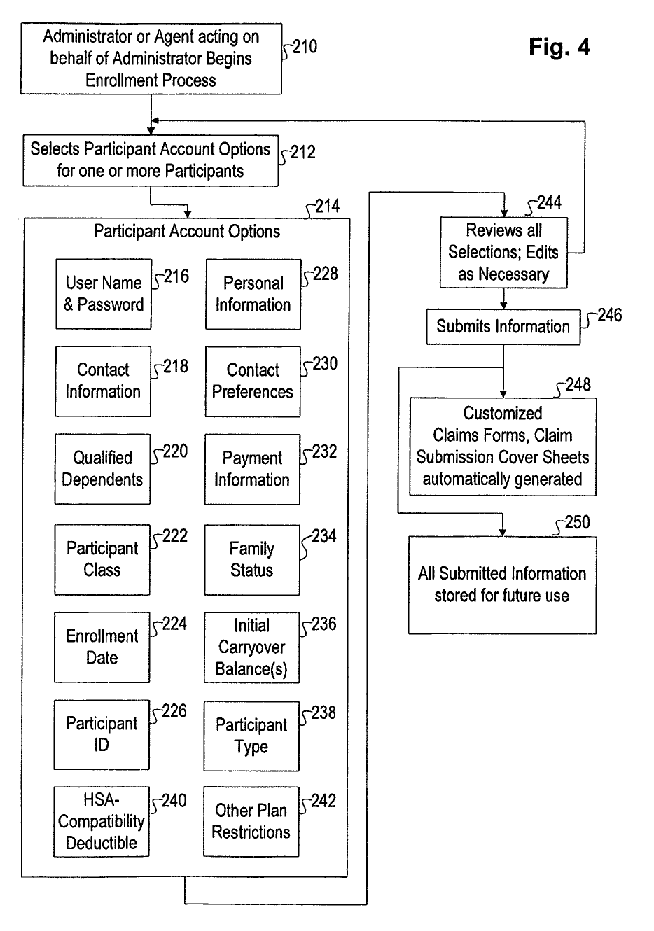

Once the administrator creates the group benefit plan, participants may be enrolled in the plan, as illustrated in FIG. 4. Participants may be enrolled 210 individually through the website 26 or in batch by uploading to the data processing system the required information in a specified format. In one embodiment, batch enrollment is done by uploading a file generated by Microsoft Excel or text editing software. The administrator selects 212 participant account options 214 for one or more participants 212. The participant account options 214 may include user name and password 216, contact information 218, qualified dependents 220 (including their relationships to the participant), participant class 222, enrollment date 224, participant ID 226, personal information 228, contact preferences 230, payment information 232, family status 234, initial carryover balance 236, HSA-Compatibility Deductible 240, and other plan restrictions 242. Additional user names and passwords, contact information, personal information, contact preferences, and payment information may be stored for the participant's spouse and dependents. In one embodiment of the invention, the administrator may enter dependent information, and/or the administrator may allow participants to enter information for their own dependents.

The participant's user name and password 216 may be stored in the same manner, employing similar encryption techniques, as the administrator's user name and password 116. Contact information 218 may also mirror administrator's contact information 118.. Qualified spouse and other dependents 220 may be used to determine their eligibility for reimbursement. The participant class 222 may be used to determine the plan design(s) 136 available to the participant. The enrollment date 224 may be used to determine the date that allowances begin accumulating in the participant's balance(s) and the date on which claims are first eligible for reimbursement. The participant ID 226 may be used as an identifier unique within the administrator's account to track the participant. The length of this number may be restricted by the participant ID number length 128. Personal information 228 may include other personal information about the participant, for example, date of birth, height, weight, health factors, and social security number. Personal information 228 may also include personal information about the participants spouse and other dependents. Contact preferences 230 may include information relating to when the participant will receive automated notification indicating total reimbursement due and status of any pending claims from the database/website server 28 and communications from the plan administrator and plan supervisor 124. In one embodiment, the participant may choose to receive automated notifications whenever a claim is submitted, whenever the supervisor processes a claim, whenever a claim is reimbursed, and/or on a regular schedule such as daily, weekly, monthly, or quarterly.

Payment information 232 may include necessary information to transfer monetary assets to the participant, for example, a postal address to receive a check and/or a bank account with routing number to receive an electronic direct deposit. Family status 234, as explained earlier, may be “Single,” “Married,” “Single with Children,” or “Married with Children.” The family status 234 may be used to determine applicable plan design 136 and/or eligibility for reimbursement. Initial carryover balance(s) 236 may be used to specify initial balance(s) for the participant in addition to any initial balance(s) 142 specified by the participant's plan design(s) 136. In one embodiment, to comply with applicable law, this could be a balance carried over from a previously existing group benefit plan. The HSA-Compatibility Deductible 240 may be used to process claims, so that the participant may maintain eligibility to contribute to his Health Savings Account (HSA) if, for example, the group plan being administered is an HRA or FSA which might otherwise limit the participant's HSA eligibility. Other plan restrictions 242 may be used to provide the database/website server 28 with information to modify the claim approval behavior subject to predetermined restrictions at the request of the participant.

The administrator may be prompted to review 244 all selections and entries made in steps 212-242 and change any option individually while retaining previous selections for all other options. Finally, the administrator submits 246 his selections, which are stored 250 in the database 30 of the website 26 for future use.

A feature of the software program is that upon completion of the enrollment process, necessary documents are automatically generated 248 in accordance with the selections made during the enrollment process. In one embodiment, this includes welcome letters, election forms, claim submission forms, and documentation submission cover sheets customized for the participant.

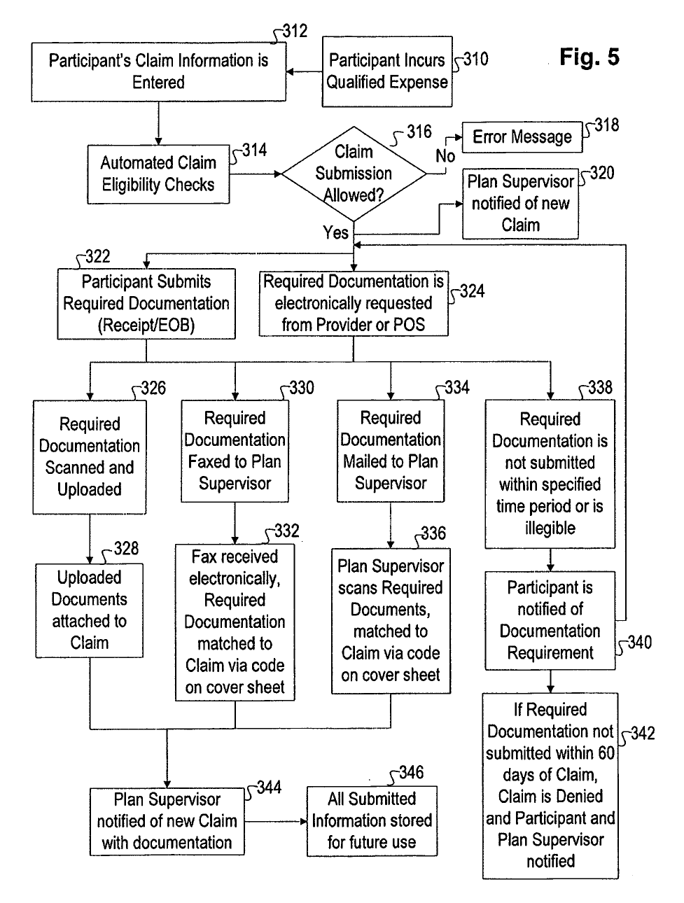

FIG. 5 is a flow diagram of a method for submitting a claim for reimbursement under the group benefits plan, according to an embodiment of the invention. A participant incurring a qualified expense 310, logs on to the website 26 using the username and password 216, and enters information 312 about the claim required for processing of the claim. Alternatively, information 312 about the claim may be submitted for review by the plan supervisor directly by the service provider of the qualified expense or by a third party acting on behalf of the participant, electronically or otherwise. In either case, the entity submitting the claim may mark the claim as being for test adjudication only; in this case the claim is processed as normal but no reimbursements are performed, rather the submitter of the claim is notified of the amount that would have been reimbursed, optionally with an explanation of how the amount was determined. This may also place a temporary lock on the participant's account to guarantee that the amount reported will in fact be approved for reimbursement if the same claim is submitted for actual adjudication within a specified timeframe. Test adjudication may be desired, for example, if a service provider wishes to determine how much of a charge will be covered by the benefit plan and how much, should be paid by the participant. In one embodiment, the claim information 312 includes the amount of the expense claimed, the date of service for the expense, a description of the nature of the expense, the name of the provider of service, the name of the person receiving service (selected from among participant and participant's qualified dependents 220). If there is more than one plan design 136 applicable to the participant, the participant or provider may be prompted to select which plan design 136 to apply to the claim. The participant or provider may identify the mode for submitting the required documentation, by way of example, scanning and uploading via a client terminal 23, faxing, mailing, e-mailing required documentation, or otherwise causing such documentation to be transmitted from the service provider. The participant or provider may optionally include notes that can be viewed by the plan supervisor and maintained in the database 30 of the website 26. In one embodiment, if the plan design(s) 136 applicable to the participant allow for reimbursement of health insurance premiums, the website 26 displays a notice requiring the participant to certify that neither his insurance carrier nor applicable regulations limit his ability to lawfully receive reimbursement for health insurance premiums without violating the terms of the health insurance contract. If the participant has elected an HSA-Compatibility Deductible 240 or other plan restrictions 242, appropriate information may be displayed for the participant's or provider's certification, including allowing the participant to optionally certify that the claim is not subject to restrictions of the HSA-Compatibility Deductible 240 or other plan restrictions 242.

According to a feature of the present disclosure, the software program may be programmed to provide instructions to a processor to receive an employer's selection of a group benefits plan from a client terminal, the group benefits plan excludes an HSA, compute at least one option for compatibility with the HSA, receive data for a participant account in the group benefits plan, transmit the at least one option for compatibility with the HSA, and receive a participant's election of one of the at least one option to modify the group benefits plan.

According to another feature of the present disclosure, the software program may be programmed to provide instructions to a processor to receive an employer's selection of a group benefits plan from a client terminal, the group benefits plan includes an HSA, compute at least one option for modifying the group benefits plan for HSA compatibility, receive data for a participant account in the group benefits plan, transmit the at least one option for modifying the group benefits plan, and receive a participant's election of one of the at least one option to modify the participant's benefits plan for HSA compatibility.

One feature of the software program is that customized claim forms and cover sheets may be automatically created for printing by participant or administrator by examining all information listed above. In one embodiment, the customized forms display the health insurance notification and the HSA-Compatibility Deductible or other plan restriction notifications only if they are applicable to that participant. The cover sheets may contain graphically-encoded information linking the documents submitted to the participant and the claim, for example, a printed bar code.

After the participant or provider submits 312 his claim information, the software program may run automated claim eligibility checks 314 to provide instant notification, where appropriate, if the claim cannot be submitted. In one embodiment, this includes verifying that the present date is within the time limit for claim submission after date of service 152, verifying that the participant has elected participation in the group benefit plan since the plan was last created or modified if election is required, verifying that the participant was enrolled and not yet terminated from the group plan on the date of service, verifying if the participant has been terminated from the group plan that the present date is within the time limit for claims submission after termination 166, and verifying that the recipient of service is the participant or a qualified spouse or dependent 220 of the participant. Should any of these checks indicate that the claim submission is invalid, the participant is notified 318 and the claim is not sent to the plan supervisor for review on a remote terminal. The plan supervisor may then contact the participant or take other corrective measure. If the participant participates in another plan for which the claim may be valid, for example a different group health benefit plan, claim information may be automatically forwarded to the other plan.

If the claim submission is allowed 316, the plan supervisor is notified 320 that a new claim has been submitted. Next, the participant or provider submits required documentation 322 according to the applicable expense documentation requirements 150 to the plan supervisor. In one embodiment, if the participant has submitted the claim, the participant has the option to enter contact information for the provider or point of sale (POS) of the service and request that the website 26 send them an automated electronic request for the required documentation 324.

Required documentation may be accepted electronically by upload through the website 326, electronically by fax machine 330, or mailed to the plan supervisor 334. Documents accepted electronically by upload 326 through the website 26 may automatically be attached 328 to the filed claim in the database 30. Documents received electronically by fax machine 330 may be scanned for a code printed on an automatically-generated fax cover sheet that links 332 the documentation to the claim in the database 30. Documents received by mail are scanned and uploaded 336 to the database/website server 28, which scans the document for a code printed on the automatically-generated mail cover sheet to link the documentation to the claim in the database 30. If the claim was not submitted with a cover sheet having a code, or the code is non-scannable, the plan supervisor may manually link the documentation to the claim.

When required documentation is stored in the database 30, the plan supervisor may automatically be notified of a new claim with required documentation 344. In the event that required documentation is not received within a specified amount of time 338, the software program may automatically notify 340 the participant of the applicable requirement for documentation 150. If the plan supervisor finds submitted documentation to be inadequate and/or illegible 338, the software program may provide an option to send an automatically-generated notice 340 to the participant explaining documentation requirements and including any notes entered by plan supervisor. The database 30 may be configured to store 346 all communications sent to the participant, either automatically or by the plan supervisor for later review by the plan supervisor. If required documentation is not submitted within a specified time period of claim submission, the software program may automatically deny 342 the claim and notify, both the participant and claim supervisor.

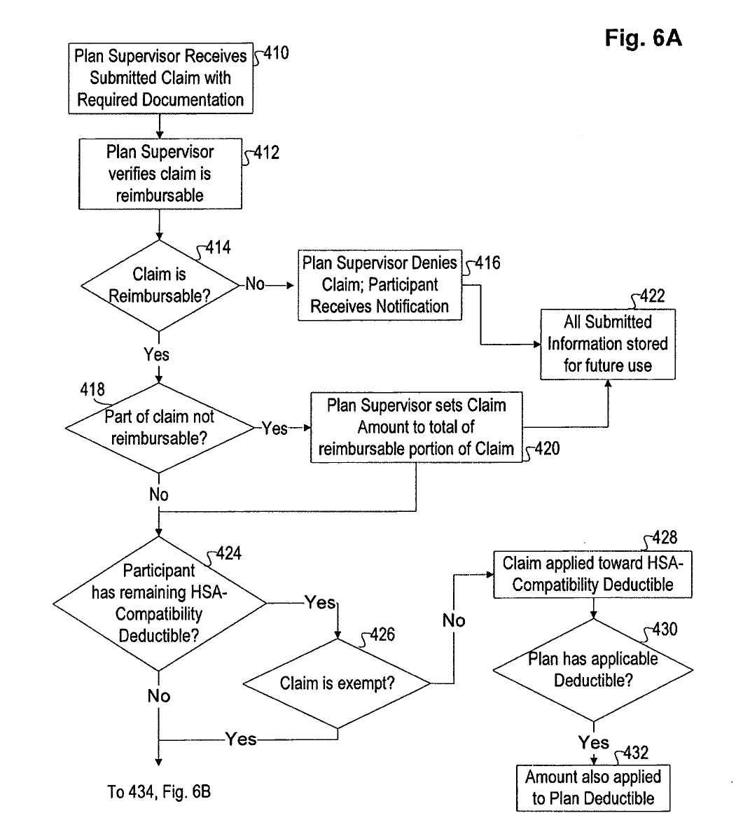

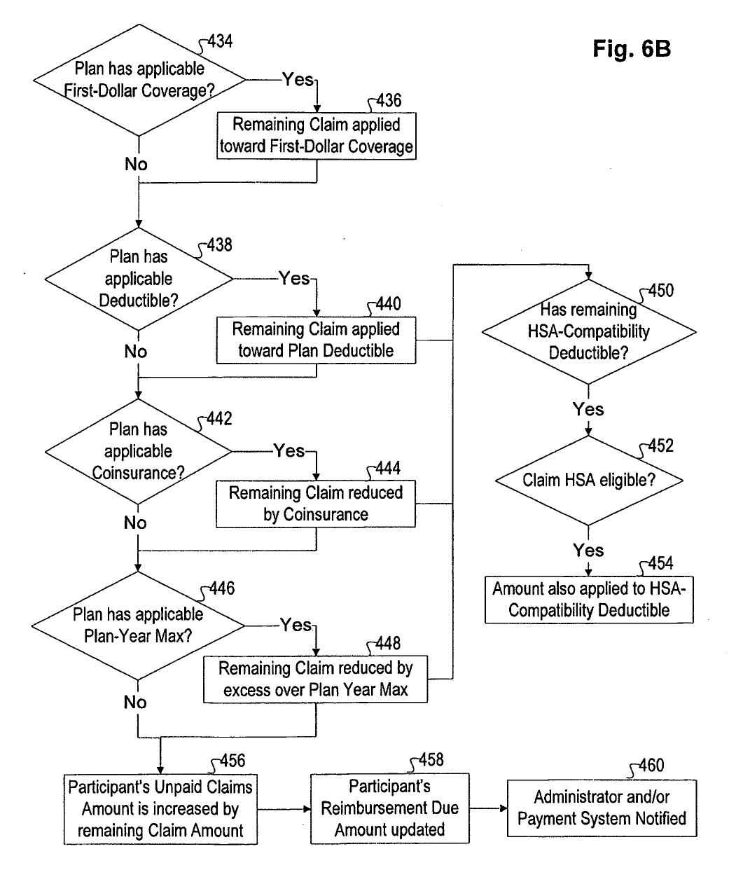

FIG. 6 is a flow diagram of a method for reviewing submitted claims under the group benefits plan, according to an embodiment of the invention. The plan supervisor receives 410 claim information with required documentation and reviews 412 the claim information to determine whether or not the claim is reimbursable 414 according to applicable plan design(s) 136 for the participant. To assist in the review of submitted claims, the website 26 displays a number of data points. In one embodiment, the data points include a summary of qualified expenses 148 for applicable plan design(s) 136, expense documentation requirements 150 for applicable plan design(s) 136, and a list of recent claims submitted by participant and their approval status.

If the claim is not reimbursable 414, the plan supervisor denies the claim and the participant receives notification of the denial along with any comments written by the plan supervisor 416. If the plan supervisor determines that a portion of the claim is not reimbursable 418, then the plan supervisor sets the claim amount to the total of all reimbursable amounts included in the claim 420. The plan supervisor may write public notes viewable by the participant and plan administrator and/or private notes stored in the website's database 30 and viewable only by the plan supervisor. If the claim or part of the claim is not reimbursable, and the participant participates in another plan for which the claim may be reimbursable, for example a different group health benefit plan, claim information may be automatically forwarded to the other plan. In either case, claim information and approval/denial may be stored in the database 446. After the plan supervisor approves part or all of the claim, the software program performs a number of checks and adjustments to the claim based on the applicable plan design(s) 136 and the participant's account options 214. For example, the software program checks whether the participant has elected an HSA-Compatibility Deductible 240 or other plan restriction 242 and/or whether there is a remaining deductible or restriction 424.

If there is a restriction, the software program may be programmed to check whether the participant has certified and the supervisor has confirmed that this claim is exempt from such restriction 426. For example, for an HSA-Compatibility Deductible 240, the claim may be exempt because the nature of expense of the claim is not subject to the HSA high-deductible requirement (e.g. preventative care, dental, vision, permitted premium result of an accident), or because the person receiving service does not wish to maintain HSA eligibility (e.g. a dependent). If the claim is not exempt, the restriction is applied. In the case of HSA-Compatibility, the lesser of the claim amount and the remaining HSA-Compatibility deductible may be calculated. The remaining claim amount and the remaining HSA-Compatibility deductible may them be reduced by this amount 428. If the Plan has a deductible to which the claim might be applied 430, any amount applied toward the HSA-Compatibility Deductible 240 may also be applied to the Plan Deductible 432.

If the applicable plan design 136 specifies a First-Dollar Coverage 167 for the claim's type of expense 434, the lesser of any remaining claim amount and remaining First-Dollar Coverage amount may be calculated. This amount may then be set aside, and the remaining claim amount and the remaining First-Dollar Coverage amount for that type of expense are both reduced by this lesser amount 436. If the applicable plan design 136 includes a deductible 144 that applies to this claim submission 438, the lesser of any remaining claim amount and remaining plan Deductible may be calculated, and both the remaining claim amount and the remaining plan Deductible amount are decreased by this lesser amount 440. If the applicable plan design 136 includes coinsurance 146 that applies to this claim submission 442, the remaining claim amount may be reduced by the percentage of coinsurance 146 specified in the plan design for its type of expense 444. If the applicable plan design includes a Plan Year Maximum amount that applies to this claim's submission 446, the amount by which the remaining claim amount exceeds the remaining Plan Year Maximum amount (if any) may be calculated. The remaining claim amount may then be reduced by this amount in excess 448. The remaining Plan Year Maximum amount may then reduced by the remaining claim amount.

A feature of the invention is that if the participant has another deductible, such as an HSA-Compatibility Deductible, which the claim may be applied to, then the amounts of reductions due to Plan Deductible 440, Coinsurance 444, or Plan Year Max 448 may then be applied to that deductible, as demonstrated in steps 450-454. As can be envisioned by a person skilled in the art, the group benefit plan may be set up with a plan restriction for rejecting claims for health insurance premiums from being applied towards the HSA-Compatibility Deductible even if they were not reimbursed.

Finally, the participant's unpaid claims amount may be increased, in step 456, by the final remaining claim amount and any amount set aside for first-dollar coverage in step 436. The claim and the participant's reimbursement due amount are updated in step 458 to be the lesser of the participant's unpaid claims amount and the participant's applicable balance. The software program may be configured to notify the plan administrator, in step 460, according to his contact preferences 120, of any change in the participant's reimbursement due amount. The software program may also be configured to send the reimbursement to another system for automatic payment if the expense qualified for automatic payment according to the reimbursement schedule 165 of the plan design. In this case, the participant's unpaid claims amount and reimbursement due amount are updated upon confirmation of a reimbursement transaction. If the claim 312 was marked as being for test-adjudication, then the participant's unpaid claims amount are not increased. As such, the plan administrator, the participant and any payment mechanism are not notified of an approved claim instead, the entity that submitted the claim (for example the participant or service provider) is notified of the amount that would have been approved for reimbursement, with an explanation of any adjustments made.

One feature of the invention is the ability for the plan supervisor at any time to easily enter a correction to the reimbursement due amount and/or remaining deductible amount(s) for any participant. Another feature of the invention is the role of the plan supervisor for verification of claims for the administrator to administer and pay the submitted claim. Traditionally, a Third Party Administrator (TPA) has an obligation to review, verify and pay claims submitted by participants. As such, the TPA has fiduciary responsibility to the employer. In contrast, the plan supervisor may not have fiduciary duties to the employer. To maintain privacy of an employee's medical history and condition, an employer self-administering a benefits plan may employ a third party plan supervisor who independently verifies that the claim submitted is a legitimate expense and then notifies the employer to pay the submitted claim.

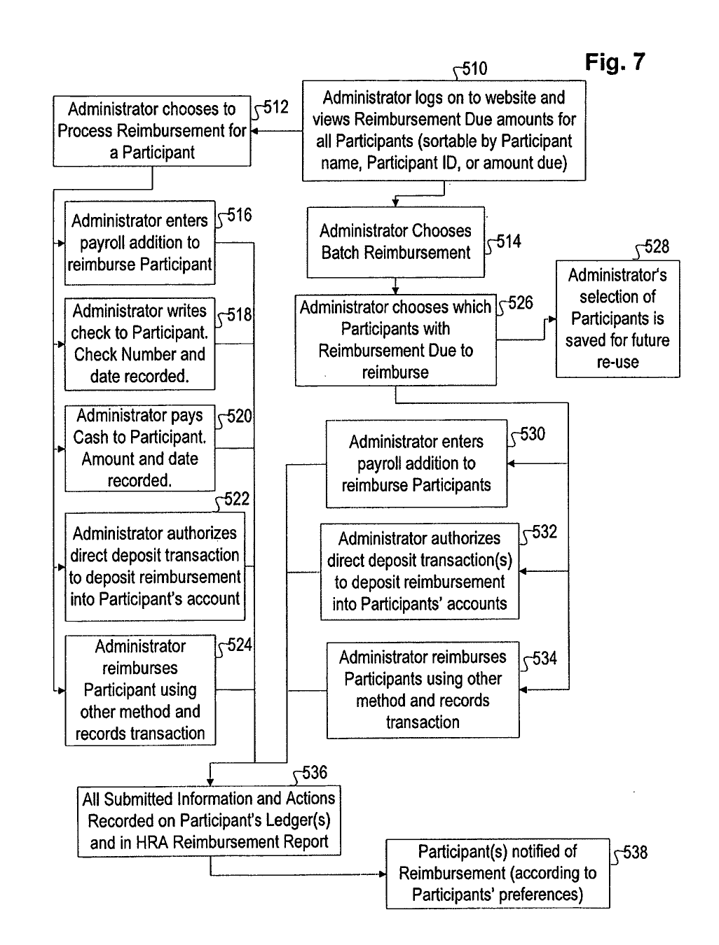

FIG. 7 is a flow diagram of a method for reimbursing participants for approved claims, according to an embodiment of the invention. The plan administrator may view 510 a list of all participants, optionally showing only those with reimbursement due amounts greater than zero, and sort this list by a number of predetermined criteria, including participant name, participant I.D., and/or reimbursement due amount. In one embodiment, the plan administrator may view the dates and amounts for which claims have been approved, but may not view details of the claims or protected information about participants, including private health information protected by HIPAA. The plan administrator may choose to reimburse a participant individually 512 or perform a batch reimbursement for multiple participants 514. The methods available to the administrator to perform reimbursement may be determined, in part, by the payment system(s) information 122 he has entered for configuration information, and in part, by the payment information 232 that has been entered into the database 30 for the participants.

The plan administrator may reimburse an individual participant with cash 520, a check 518, payroll addition 516, direct deposit 522, or any other predetermined payment method 524. The plan administrator may perform an automated batch reimbursement of multiple participants with payroll additions 530, direct deposits 532, or other predetermined payment methods 534. When performing batch reimbursement, the plan administrator may select which participants with reimbursement due amounts above zero to include in the batch reimbursement 526 (and which participants to exclude), and this selection may be stored for future re-use 528. When a reimbursement is made, information about the reimbursement, including an identifier for the transaction, payment method, amount, date and time, is stored in the database 30 and can be viewed by the affected participants, the plan supervisor, and the plan administrator 536. Finally, participants are notified 538 of the reimbursement in accordance with their contact preferences 230 and their reimbursement due amounts are reduced by the amount of the reimbursement they received. In the case of reimbursements made by payroll additions or direct deposits, the reimbursement data may be transmitted electronically to the payroll system or bank, or the administrator may be required to transfer information from the software program to another system, such as the payroll system or a banking system, to complete the reimbursement. The invention can export this information in a variety of formats that may include a Microsoft Excel file, a CSV file, a web page, a NACHA file, or other formats.

One feature of the invention is the ability for the administrator, at any time, to easily enter a correction to any past reimbursement to a participant if the reimbursement amount was incorrect for any reason. Also, if a batch reimbursement fails to take place, the administrator may void the reimbursement batch, voiding all records created by that batch and automatically adjusting each participant's reimbursement due amount to reflect that the reimbursement was not made.

Another feature of the present disclosure includes a method, machine-readable medium and system for administering a defined-contribution benefits plan. In one embodiment, the system includes a processor configured to receive a first data for a participant account in a group benefits plan, retrieve a plan design option for the participant account, retrieve a second data for an allowance amount to be applied to the participant account for reimbursement, and receive a claim submission for the participant account. The processor may further configured to determine reimbursement for the claim submission of a qualified medical expense from the allowance amount and the plan design option.

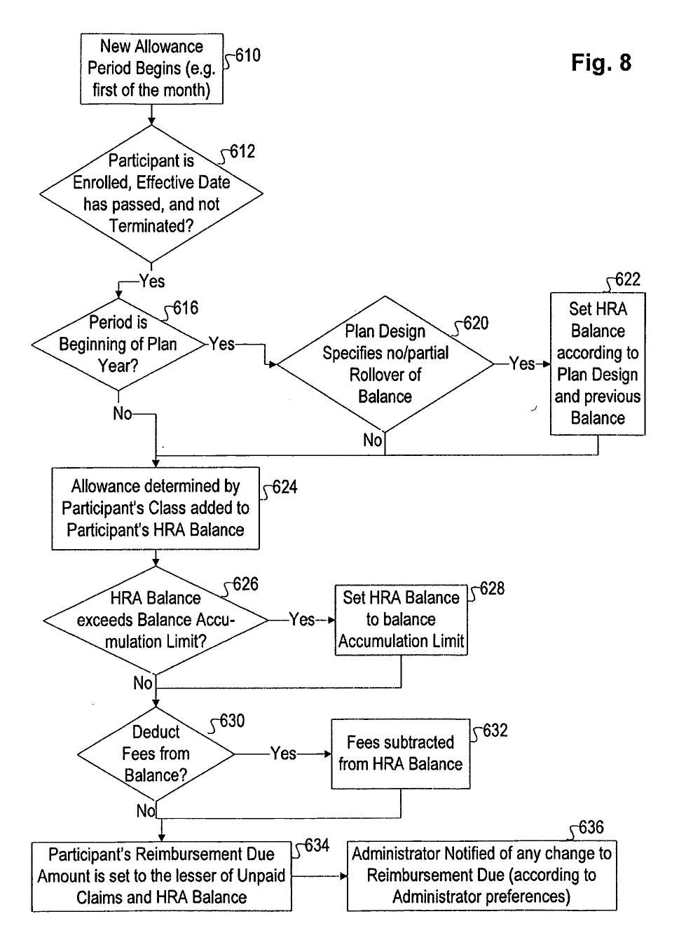

FIG. 8 is a flow diagram of a method for periodically adjusting a participant's balance, according to an embodiment of the invention. This method may occur at the beginning 610 of any new allowance period 154 for any plan design 136 or at the initiation of the administrator, and is run with respect to every participant to whom the plan design 136 applies. For example, when the allowance period is per hour, the administrator may input the number of hours worked by each participant on a regular schedule, such as biweekly. The software program may be configured to run eligibility checks 612, such as, determining if the participant has been enrolled in the group benefit plan, participant has not since been terminated from the group benefit plan, the present date is on or after the benefit plan's effective date 126, and the present date is on or after the participant's enrollment date 224. If eligibility checks 612 are passed, the software program may be used to determine 616 if the present date marks the beginning of a new plan year 126. If so, the participant's balance for the plan is set according to its present balance and the plan year rollover rules 140 for the plan, in step 622, if the plan design 136 specifies any rollover amount other than 100% of the balance 620.

According to an embodiment of the invention, the software program may be configured to run regular checks on whether the current date marks the end of a deductible period 160 or HSA-Compatibility Deductible period according to current regulations. If so, remaining amounts of such deductibles for all participants the deductible is applicable to, are set to the deductible amounts specified in 144 and 240. The software- program may also make regular adjustments to data stored in accordance with other plan restrictions 242.

In step 624, the participant's balance for the plan is increased by the amount of the plan design's allowance amount 138. If the participant's balance exceeds 626 any balance accumulation limit 158, the balance is set to the balance accumulation limit 158, in step 628. If the plan design 136 includes any automatic scheduled fee deductions 164, these are deducted from the participant's balance, in steps 630 and 632. After all adjustments, the participant's reimbursement due amount for the plan is set to the lesser of the participant's unpaid claims amount and the participant's balance, in step 634. Finally, if there is a resultant change in the participant's reimbursement due amount, the plan administrator may be notified 636 according to the plan administrator contact preferences 120.

It can be envisioned that the software program is configured to allow the administrator and participant to view, download, and save reports containing all the information visible to them through the webpage 26. Further, the administrator may download all information in his account (including all data entered and actions taken by employee, supervisor, or administrator) in an encoded format for off-site backup. Customized versions of the software program may also be created for the benefit of third-party distributors, including customized sign up processes.

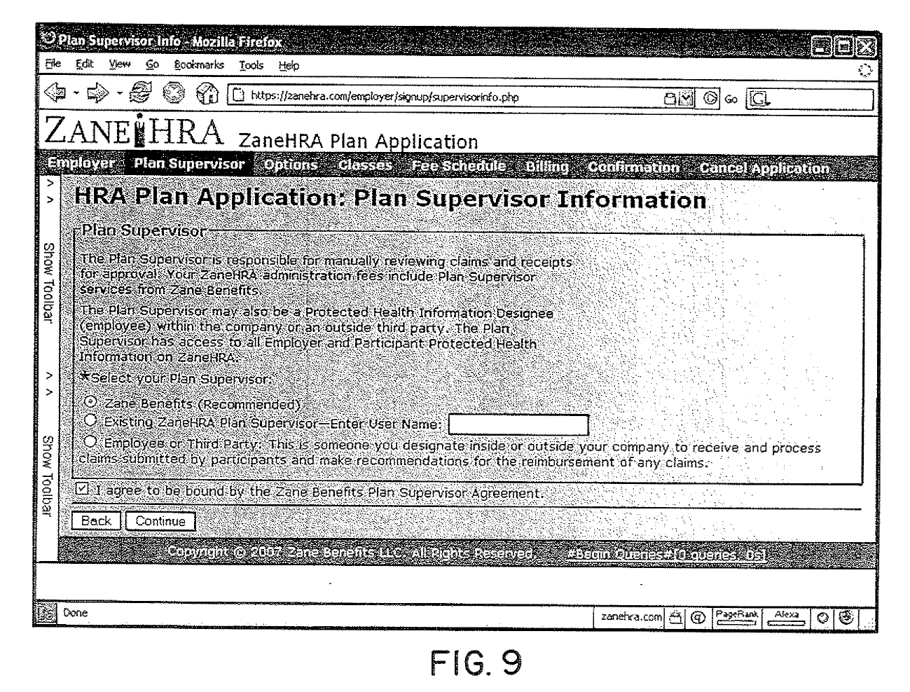

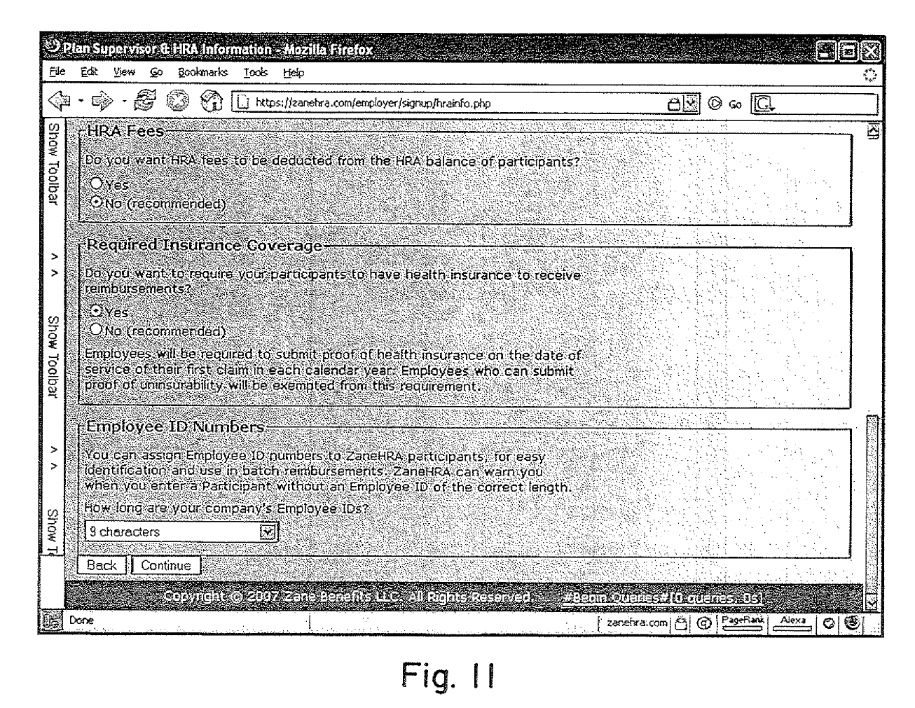

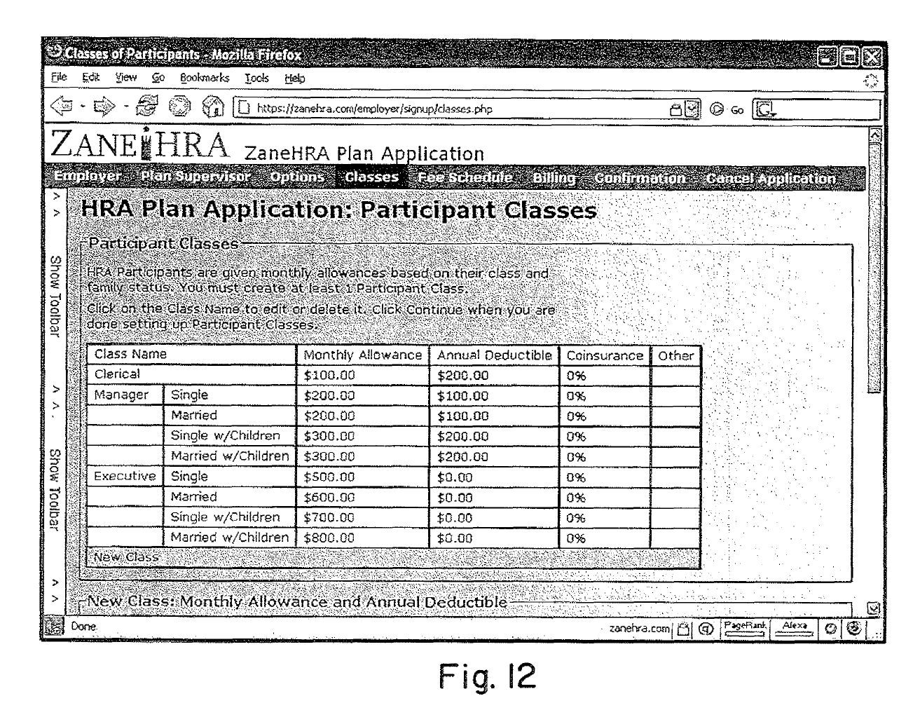

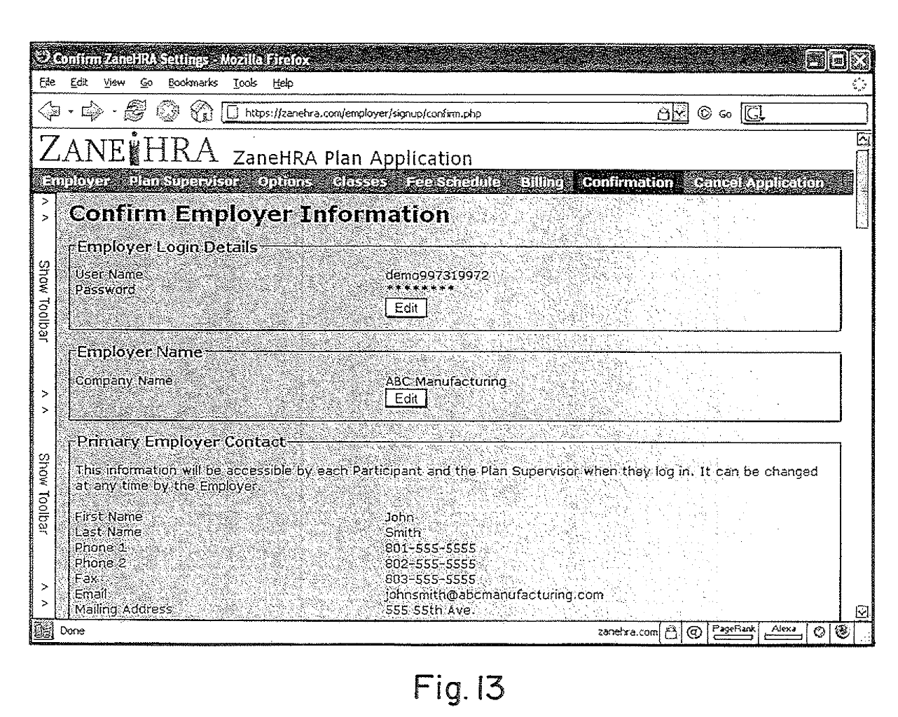

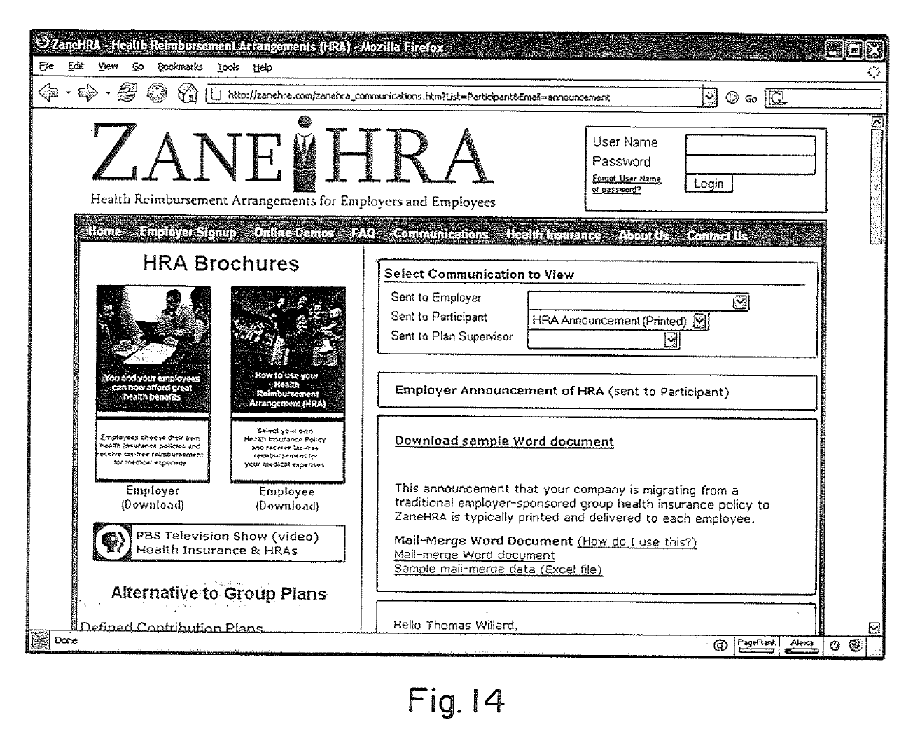

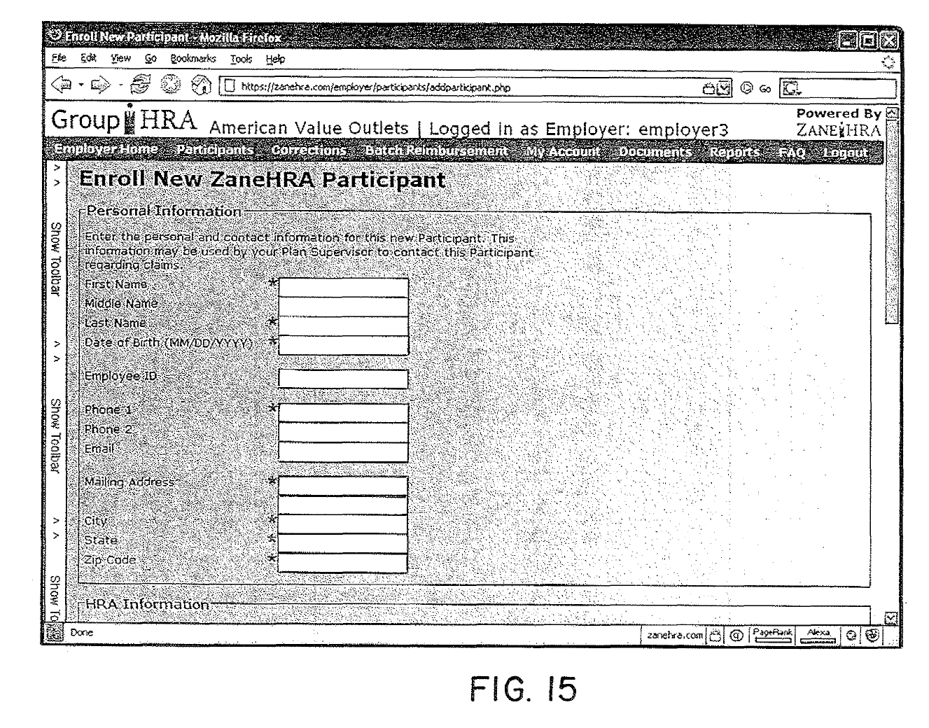

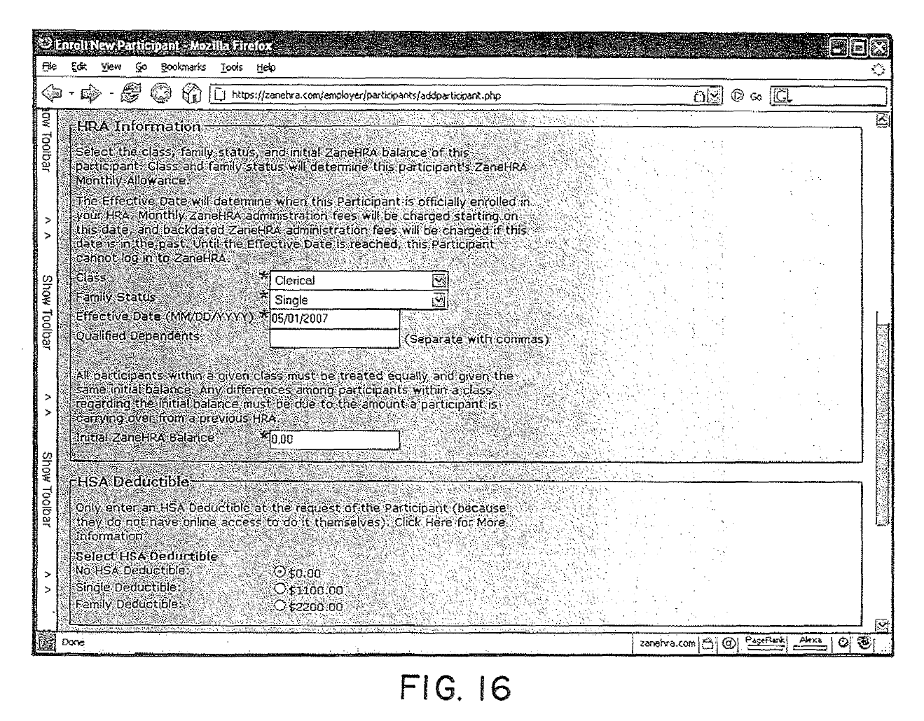

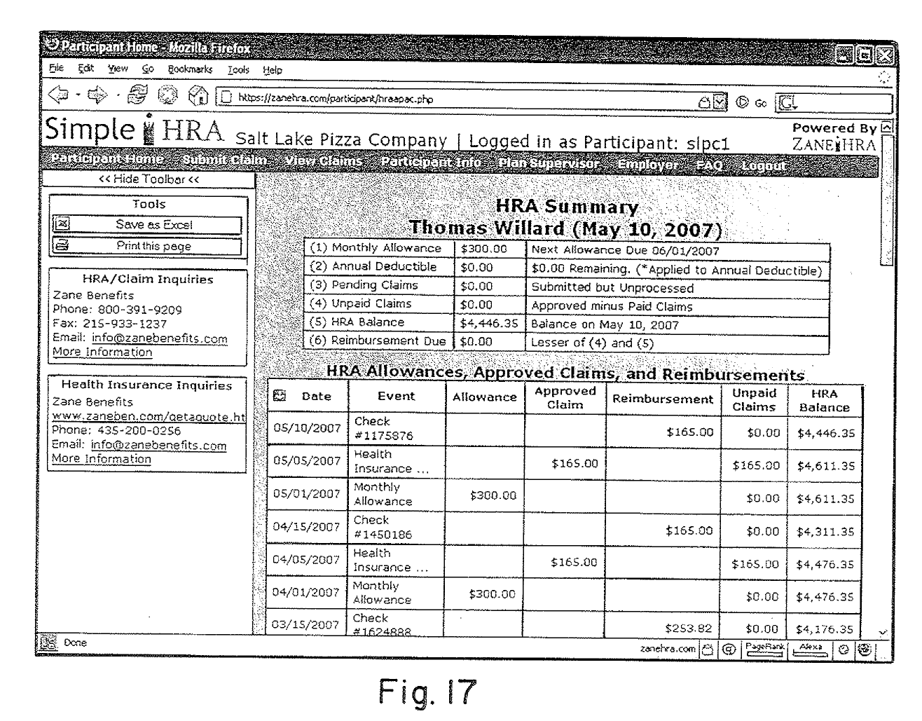

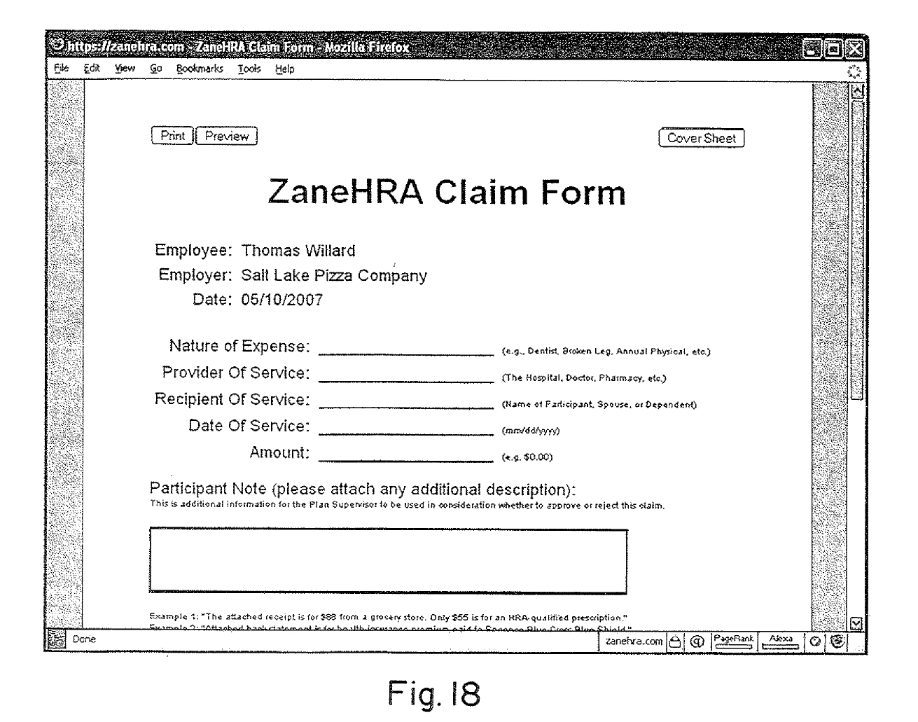

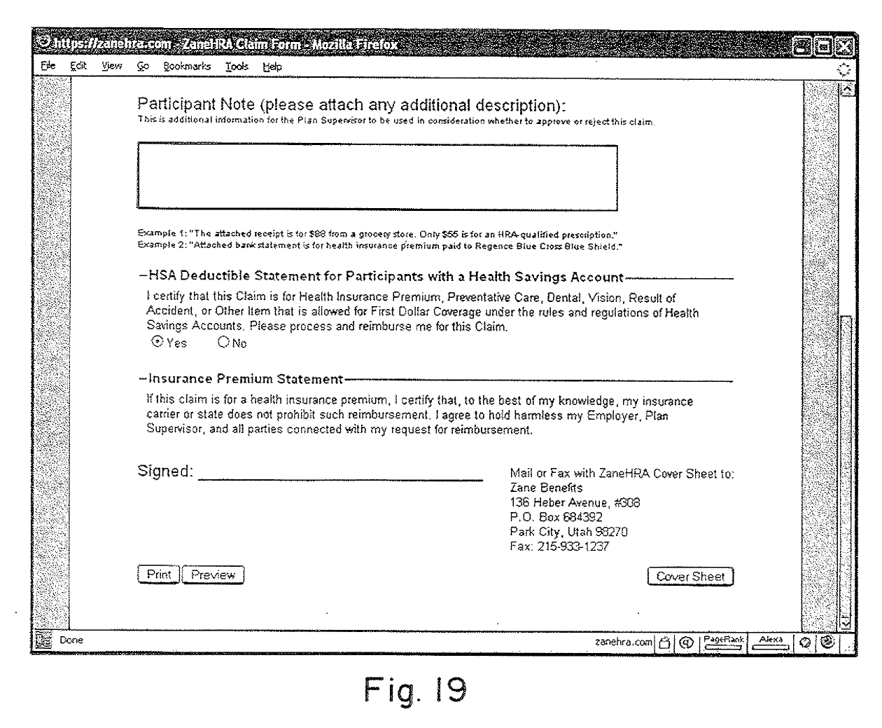

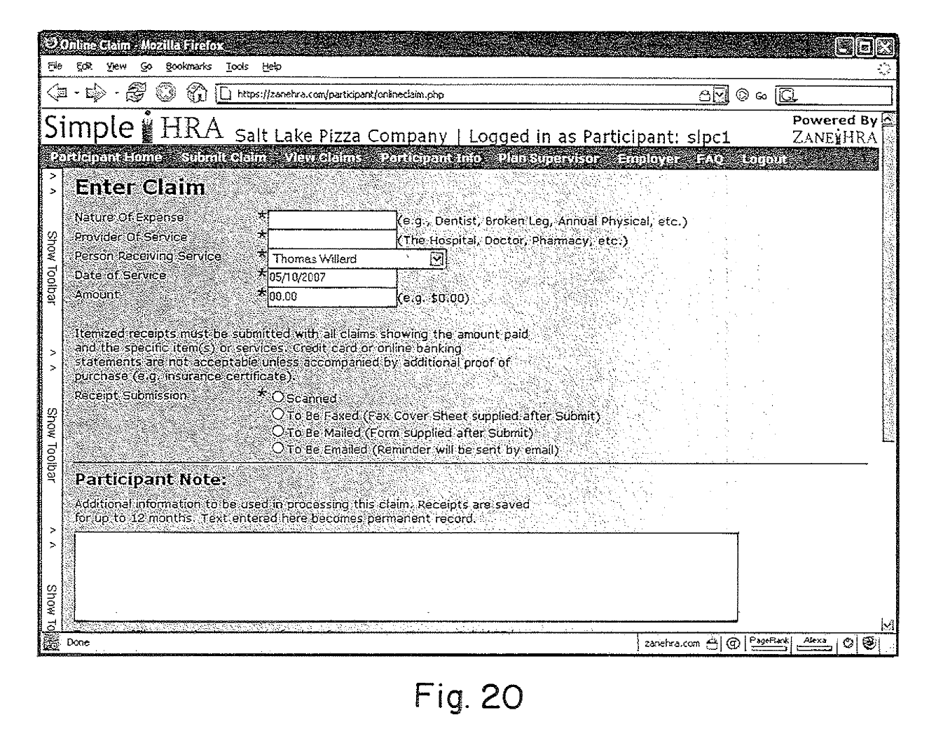

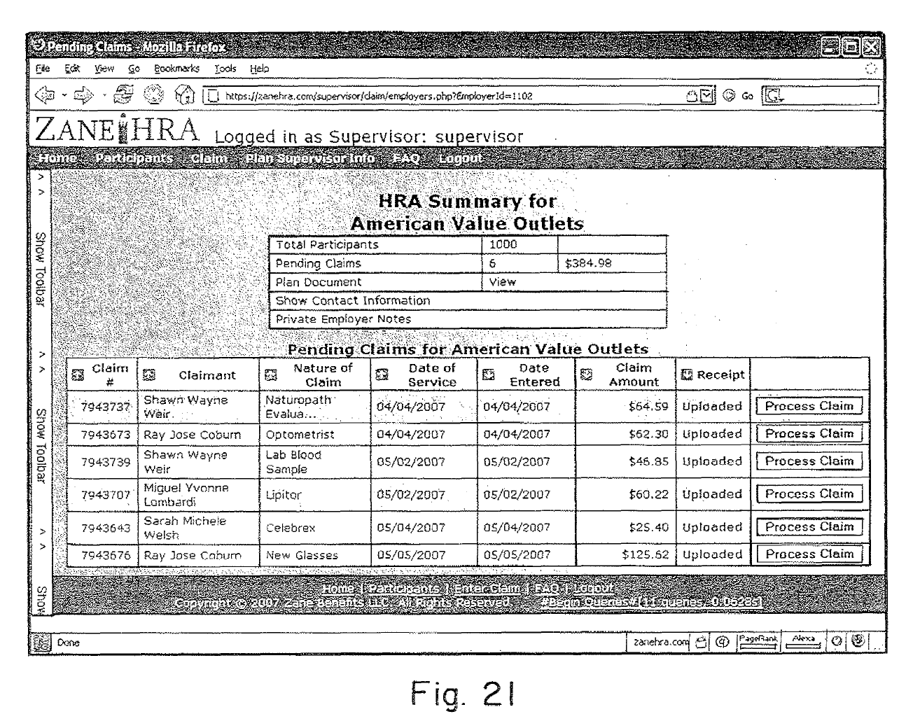

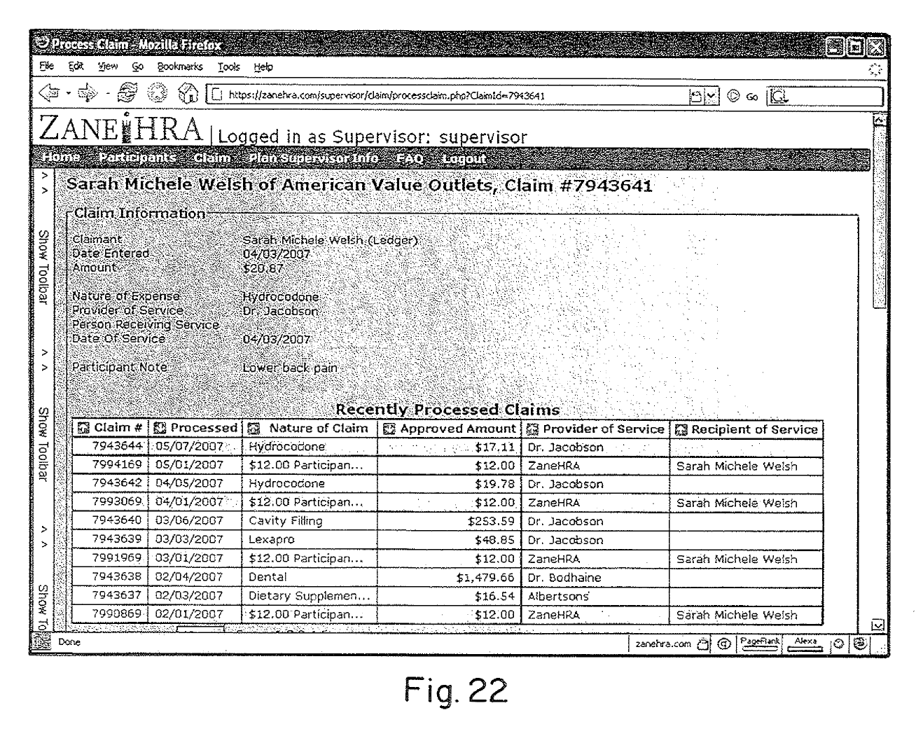

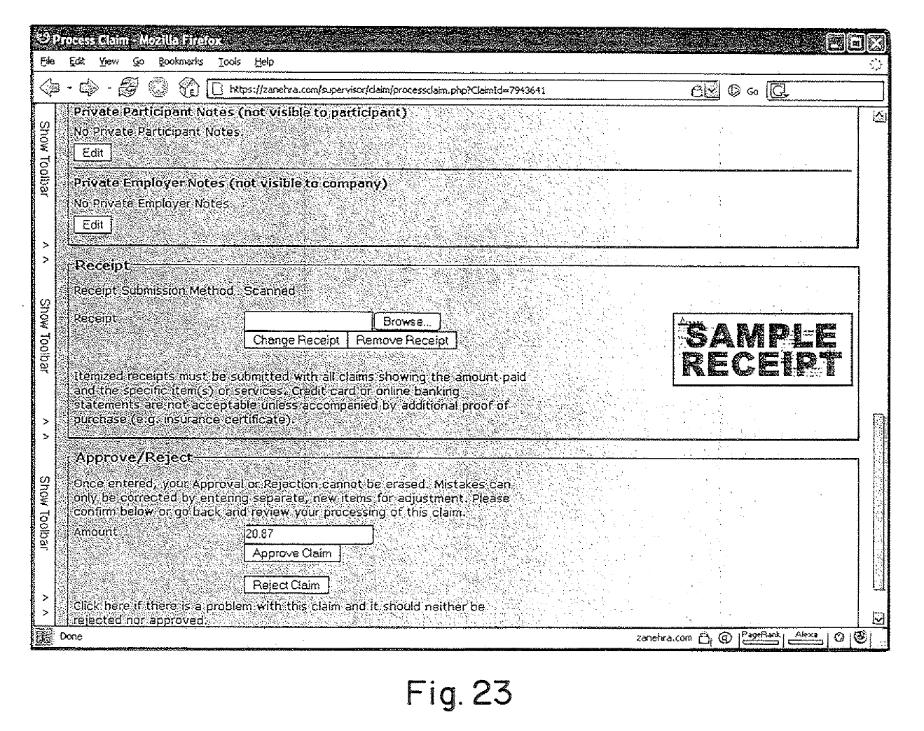

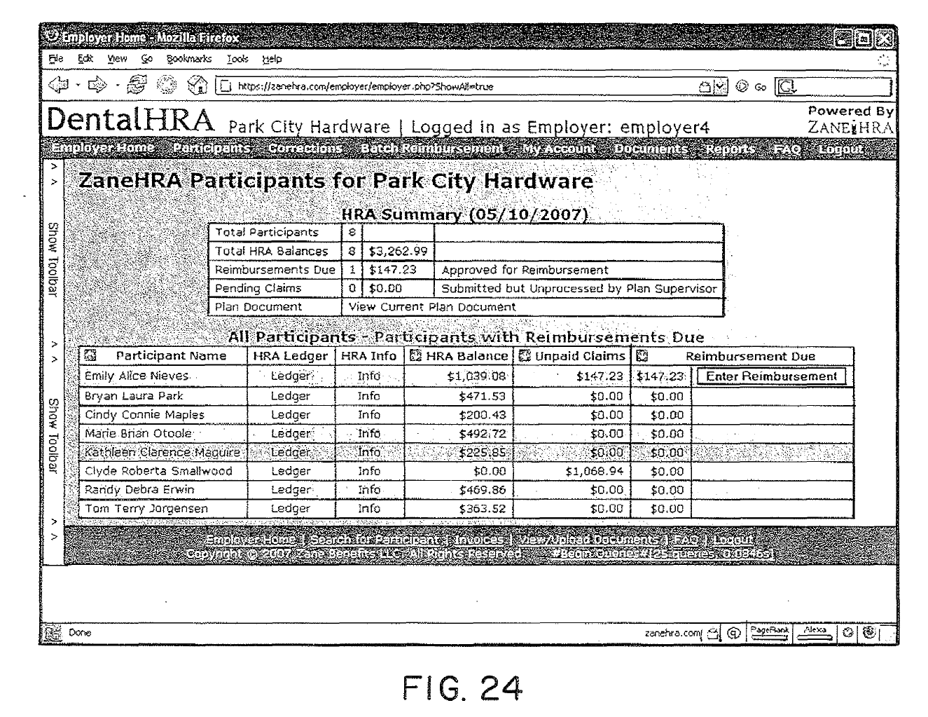

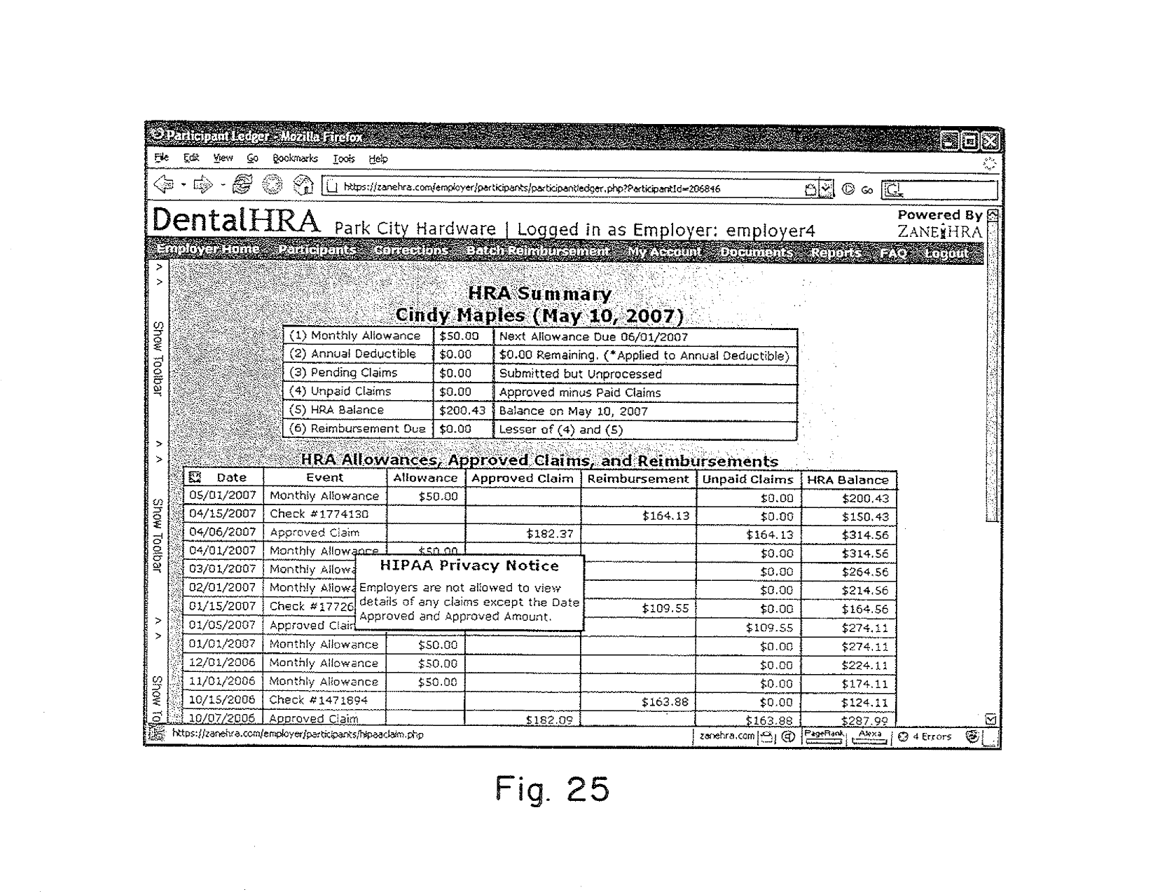

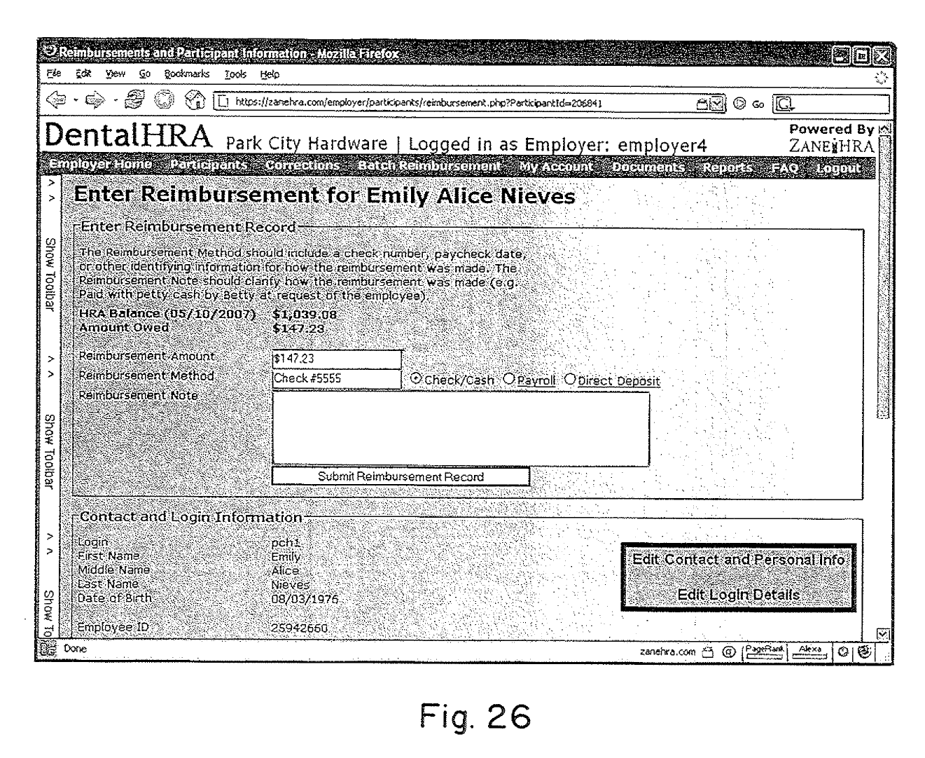

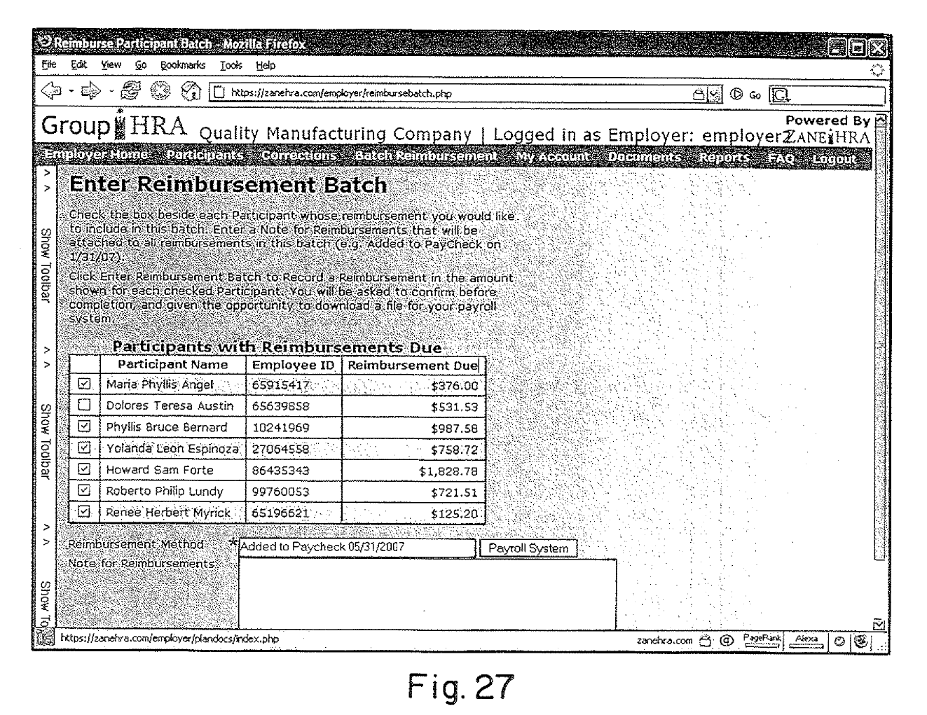

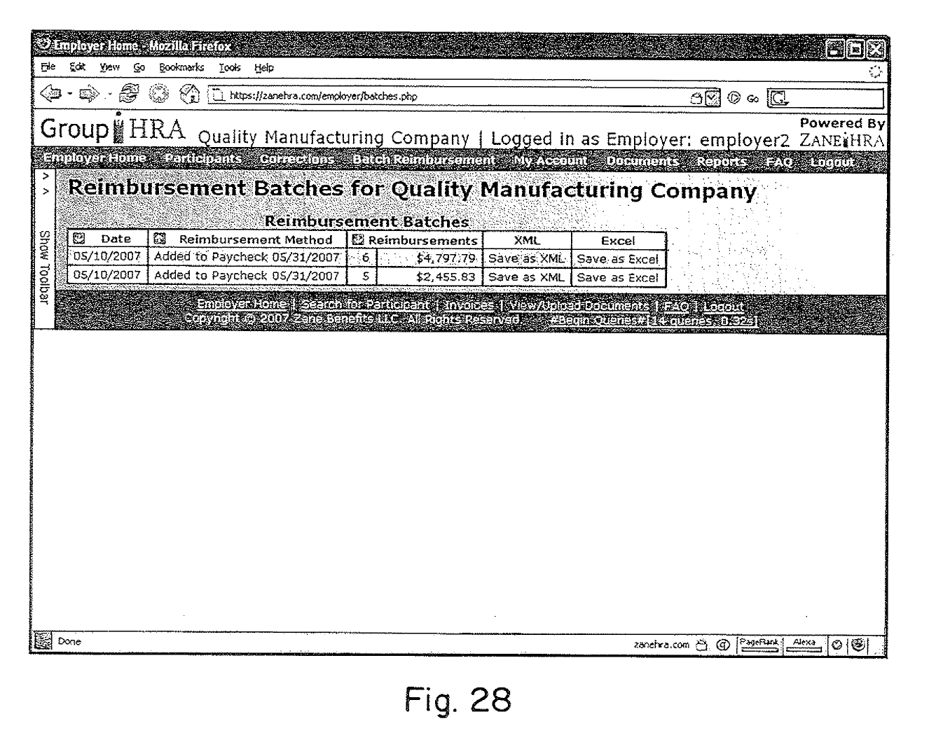

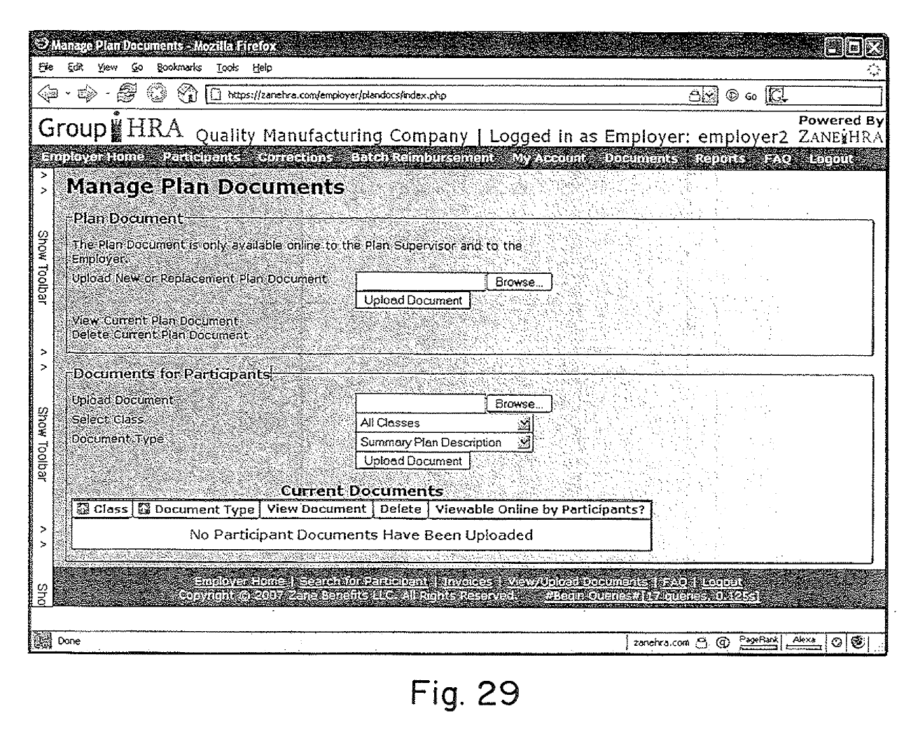

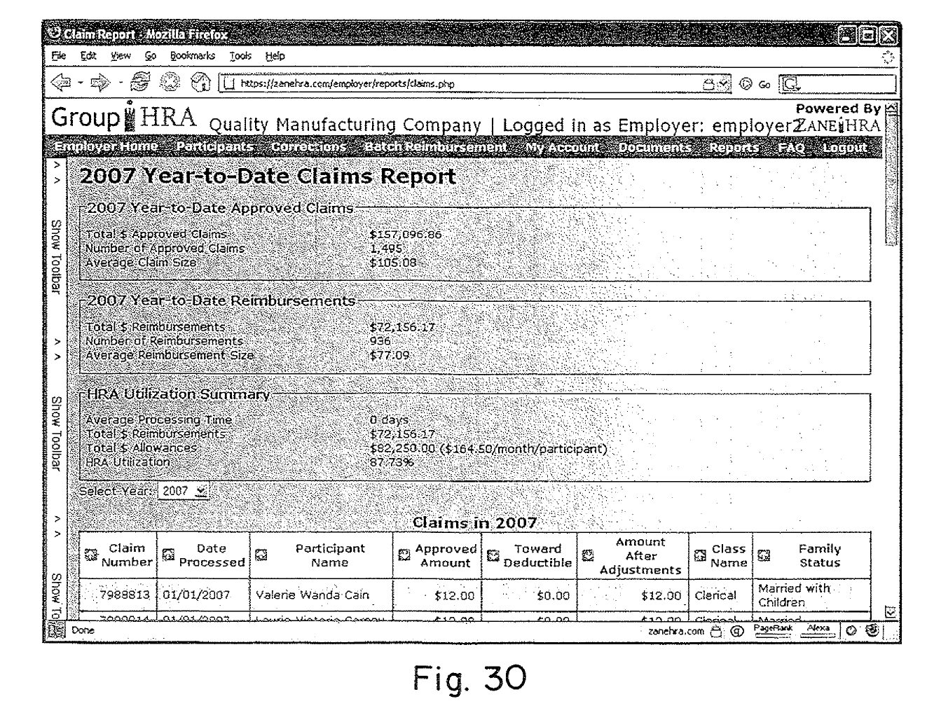

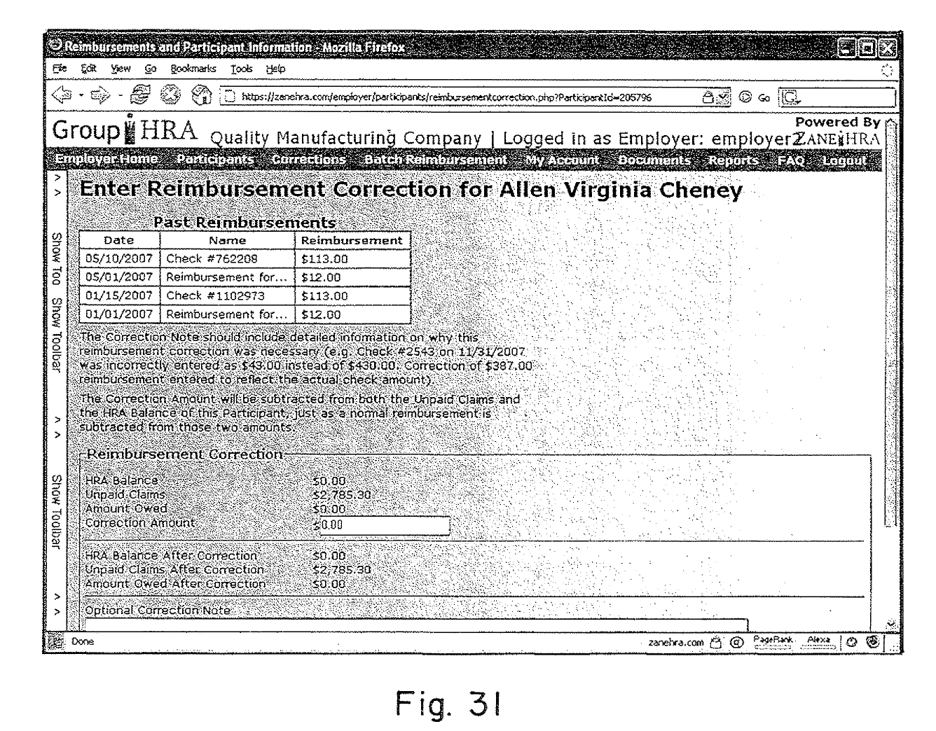

FIGS. 9-13 are exemplary web pages illustrating features of the plan creation process outlined in FIGS. 3A-3B. FIG. 14 is an exemplary webpage illustrating the ability to select, examine, and download various of the communications messages generated by the software. FIGS. 15-16 are exemplary web pages illustrating features of the participant enrollment process outlined in FIG. 4. FIGS. 17-20 are exemplary web pages illustrating features of the claim submission process outlined in FIG. 5. FIGS. 21-23 are exemplary web pages illustrating features of the claim approval process outlined in FIG. 6. FIGS. 24-28 are exemplary-web pages illustrating features of the reimbursement process outlined in FIG. 7. FIGS. 29-31 are exemplary web pages illustrating other features of the software utilized by the plan administrator.

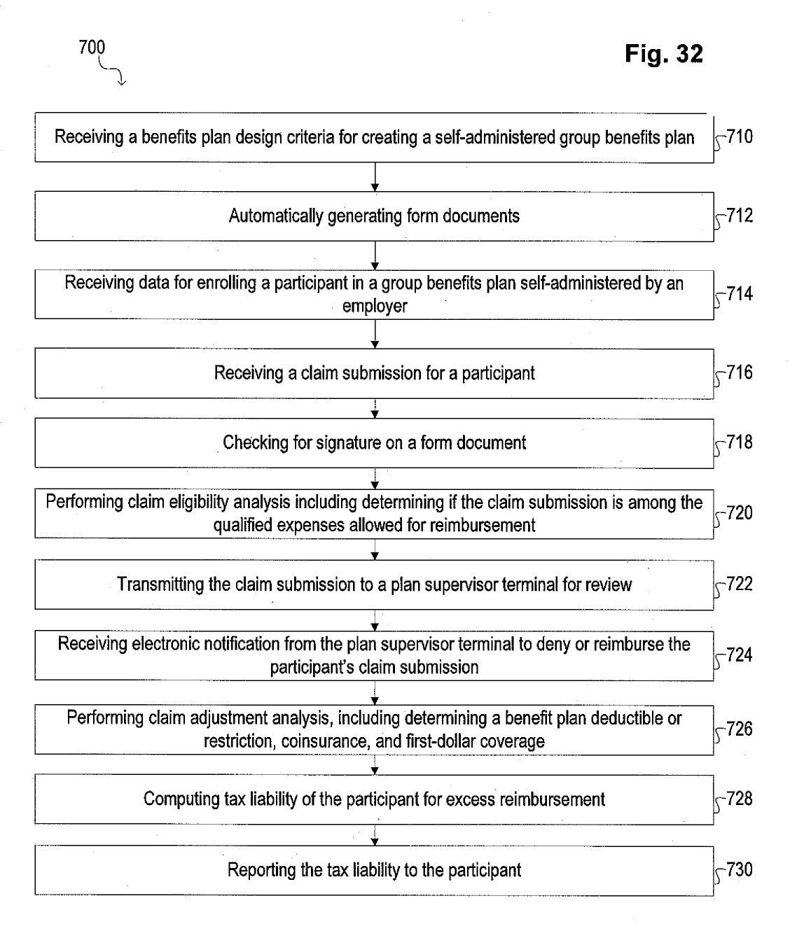

FIG. 32 is a flow diagram 700 of a computer-implemented method for self-administering a group benefits plan, according to an embodiment of the invention. The computer-implemented method, employing a processor, begins by receiving a benefits plan design criteria for creating a self-administered group benefits plan (710). The benefits plan design criteria may depend on a qualified expense, a participant class, and a family status. A participant, once enrolled, may elect a lesser coverage to the group benefits plan via the website 26. After the group benefits plan is setup, the processor may automatically generate electronic form documents, such as Plan Documents and Summary Plan Description documents (712). The processor may then receive data for enrolling one or more participants in a group benefits plan self-administered by an employer (714). The participant may be an employee, an employee's spouse and an employee's dependent. The employee's spouse and dependent may have a separate account from the employee to maintain the privacy of the spouse's or dependent's claim submissions, though the benefits may be shared.

After a participant is enrolled, the participant may submit a claim submission via website 26 and received by the processor (716). In one embodiment, the method includes, electronically or otherwise, checking for a participant's signature on the form documents (718). In another embodiment, the method includes performing claim eligibility analysis of the claim submission, including determining if the claim submission is among the qualified expenses allowed for reimbursement (720). The claim submission is then transmitted to a plan supervisor terminal or computer for review (722). The plan supervisor independently verifies that the claim submission is a legitimate expense. Upon review of the claim submission, the plan supervisor transmits back to the processor, via the plan supervisor terminal, an electronic notification for denying or reimbursing the participants claim submission (724). If the plan supervisor's notification is for claim reimbursement, the processor may be configured to perform claim adjustment analysis, including determining a benefit plan deductible or restriction, co-insurance and first-dollar coverage (726). In one embodiment, the employer's account may be integrated with the group benefits plan to pay for reimbursable claim submissions. In another embodiment, the method may include computing tax liability of the participant for excess reimbursement (728) and reporting the tax liability to the participant at the end of a tax-year (730).

One feature of the invention is the ability to create a vendor account on the software program. In one embodiment, a vendor account may be created by a medical provider, insurance agency, individual, or other entity. The software program stores information about the vendor account, including a user name & password, contact information, contact preferences, similar to 116, 118, 120, respectively, and other information. The vendor may log on to the website 26 and view information about participants. The information may include contact information and other information as allowed by law. Participant election forms may automatically be generated so as to allow the electing participant to grant his plan administrator the right to access certain participant information for vendors and/or to request information from vendors. In addition, the participant may at any time withdraw his election to allow the vendor to contact him or view his information, for example by changing an option online in his participant account. The software program may provide features to the vendor allowing the vendor to easily communicate with and/or sell products to participants. All information inputted by vendor including account information and communications and sales to participants may be stored in the database 30 for future use.

According to a feature of the present disclosure, a method, machine-readable medium and system for facilitating the delivery of marketing material to participants of a group benefits plan is disclosed. The system having a processor configured to receive data for a participant account in the group benefits plan, the data having a contact information, and grant a third party vendor with limited access to the data for acquiring the contact information for delivery of the marketing material.

According to an embodiment of the invention, the software program may be configured to provide a platform and means to facilitate self-administration of a group benefits plan. This is particularly useful for small businesses that cannot afford the expenses associated with third party administration. In another embodiment, the software program may be configured to facilitate a partial self-administration of a group benefits plan, where certain features of the group benefits plan are administered by the employer, while others are administered by a Third Party Administrator (TPA).

According to an embodiment of the invention, the software program may be configured to provide a platform and means to facilitate automatic payment of claims to third-party service providers, such as pharmacies, insurance companies collecting premiums, doctors, hospitals, etc. Since the software program may be configured to act as an adjudicator informing of funds available and amount covered by the HRA account, it may not process payment directly. Hence, to facilitate automatic payment, the software program may, for example, be integrated with a card or other mechanism that is linked directly to an employer's credit card or bank account.

In another embodiment, the software program may be configured to calculate the tax liability of employees I participants in a self-insured medical reimbursement plan such as a Health Reimbursement Arrangement (HRA). For example, the software program may be configured to compute the tax liability of highly compensated employees if they receive “excess reimbursement” from an HRA. According to the Internal Revenue Code, there are consequences if an HRA discriminates in favor of a Highly-Compensated Employee (HCE) with respect to (a) eligibility to participate or (b) benefits. There are several scenarios under which a plan may discriminate as to eligibility, including a determination of disallowed discrimination by an authoritative government entity. In this case, any HCE receiving benefits should pay taxes on a fraction of the benefits they receive that is equal to the total amounts received by HCEs in the plan divided by the total amounts received by all participants in the plan. For example, if an HCE in a plan that discriminates as to eligibility received $1,000 in benefits, all HCEs in the plan collectively received $10,000 in benefits, and the plan paid $40,000 in total benefits to all participants, then the HCE in question would owe taxes on $250. The plan discriminates in terms of benefits if (i) an HCE receives a benefit that a similarly-situated non-HCE would not be allowed to receive (e.g. dental), or (ii) an HCE receives more benefit than a similarly-situated non-HCE would have been allowed to receive [e.g. higher annual maximum]. In either case, the excess amount over what the non-HCE had access to must be computed and the HCE receiving must report the excess amount as earned income and pay taxes on it, per Treasury Regulations, Subchapter A, Sec. 1.105-11 (c)-(f) and Internal Revenue Code Section 105(h). As can be envisioned by a person skilled in the art, the software program may be configured to compute and report the tax liability to the participant receiving excess reimbursement under the group benefit plan at the close of each tax year.

According to a feature of the present invention, the group benefit plan may be changed or edited by an employer or plan administrator at any. The software program may be programmed to generate a new Plan Document and new Summary Plan Descriptions (SPDs) reflecting any changes in the plan design. The software program may be configured to make a list of all participants affected by the changes. Whenever an affected participant logs in, they may be notified that they need to acknowledge receipt of the updated SPD, and allowed to download the SPD. The administrator can print paper acknowledgment forms and manually check off acknowledgment for participants who don't use the online system. Claims for anyone affected by the change may not be approved while they are on the list and/or have not yet acknowledged the change.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Such terms should be interpreted in their most expansive forms so as to afford the applicant the broadest coverage legally permissible.

1. A computer-implemented method for self-administering a group benefits plan comprising:
receiving data for enrolling a participant in a group benefits plan self-administered by an employer;
receiving a claim submission for the participant;
transmitting the claim submission to a plan supervisor terminal for review; and
receiving electronic notification from the plan supervisor to deny or reimburse the participant's claim submission.

2. The computer-implemented method of claim 1, further comprising receiving a benefits plan design criteria for creating a self-administered group benefits plan prior to the step of receiving data for enrolling a participant in the group benefits plan.

3. The computer-implemented method of claim 2, wherein the benefits plan design criteria depends on a qualified expense, a participant class, a participant status, and a family status.

4. The computer-implemented method of claim 2, further comprising automatically generating form documents after the step of receiving a benefits plan design criteria for creating a self-administered group benefits plan.

5. The computer-implemented method of claim 1, further comprising checking for a signature on a form document after the step of receiving a claim submission for the participant.

6. The computer-implemented method of claim 1, receiving an election of a lesser coverage to the group benefits plan for the participant.

7. The computer-implemented method of claim 1, further comprising receiving a list of qualified expenses allowed for reimbursement.

8. The computer-implemented method of claim 1, further comprising performing claim eligibility analysis prior to the step of transmitting the claim submission to a plan supervisor for review.

9. The computer-implemented method of claim 1, further comprising performing claim adjustment analysis after the step of receiving electronic notification from the plan supervisor.

10. The computer-implemented method of claim 9, wherein the claim adjustment analysis comprises determining a benefit plan deductible or restriction.

11. The computer-implemented method of claim 1, further comprising determining if the participant has coinsurance.

12. The computer-implemented method of claim 1, further comprising determining if the participant has a first-dollar coverage.

13. The computer-implemented method of claim 1, wherein the plan supervisor independently verifies that the claim submission is a legitimate expense.

14. The computer-implemented method of claim 1, further comprising granting access to a vendor to view a participant's claim submission.

15. The computer-implemented method of claim 1, further comprising integrating an employer's account with the group benefits plan.

16. The computer-implemented method of claim 1, further comprising:
computing tax liability of the participant for excess reimbursement; and
reporting the tax liability to the participant.

17. The computer-implemented method of claim 1, wherein the group benefits plan is selected from a group consisting of a Health Savings Account, a Health Reimbursement Arrangement and a Flexible Spending Account.

18. The computer-implemented method of claim 1, wherein the participant is selected from a group consisting of an employee, an employee's spouse and an employee's dependent.

19. The computer-implemented method of claim 18, wherein the employee's spouse or dependant has a separate account from the employee to maintain the privacy of the spouse's or dependant's claim submissions.

20. A system for self-administering a group benefits plan comprising:
a processor configured to:
receive data for enrolling a participant in a group benefits plan self-administered by an employer,
receive a claim submission for the participant,
transmit the claim submission for review, and
receive electronic notification to deny or reimburse the participant's claim submission.

21. The system of claim 20, wherein the processor is further configured to receive a benefits plan design criteria for creating a self-administered group benefits plan.

22. The system of claim 21, wherein the processor is further configured to receive a modification of the benefits plan design criteria for a lesser coverage for the participant.

23. The system of claim 20, wherein the processor is further configured to perform claim eligibility analysis prior to transmitting the claim submission for review.

24. The system of claim 20, wherein the processor is further configured to perform claim adjustment analysis after receiving electronic notification to deny or reimburse the participant's claim submission.

25. The system of claim 20, wherein the processor is further configured to determine if the participant has a first-dollar coverage.

26. The system of claim 20, wherein the processor is further configured to:
compute tax liability of the participant for excess reimbursement, and report the tax liability to the participant.

27. The system of claim 20, wherein the claim submission is reviewed at a remote terminal by a plan supervisor.

28. A machine-readable medium that provides instructions, which when read by a processor, cause the machine to perform operations comprising:
receiving data for enrolling a participant in a group benefits plan self-administered by an employer;
receiving a claim submission for the participant;
transmitting the claim submission for review; and
receiving electronic notification to deny or reimburse the participant's claim submission.

29. The machine-readable medium of claim 28, further comprising receiving a benefits plan design criteria for creating a self-administered group benefits plan prior to receiving data for enrolling a participant in the group benefits plan.

30. The machine-readable medium of claim 28, further comprising:
computing tax liability of the participant for excess reimbursement; and
reporting the tax liability to the participant.

31. A system for administering a defined-contribution benefits plan comprising:
a processor configured to receive a first data for a plurality of participant classes in the defined-contribution benefits plan, wherein at least one of the plurality of the participant classes having a health benefit coverage different from the others.

32. The system of claim 31, wherein the at least one of the plurality of the participant classes having a claim eligibility different from the others.

33. The system of claim 31, wherein the at least one of the plurality of the participant classes having a first dollar coverage different from the others.

34. The system of claim 31 wherein the processor is further configured to receive a second data for a participant's status in the group benefits plan, wherein the participant's status is selected from a group consisting of a retired status and a new hire status.

35. A system for administering a defined-contribution benefits plan comprising:
a processor configured to:
receive a first data for a participant account in a group benefits plan,
retrieve a plan design option for the participant account,
retrieve a second data for an allowance amount to be applied to the participant account for reimbursement, and
receive a claim submission for the participant account.

36. The system of claim 35, wherein the processor is further configured to determine reimbursement for the claim submission of a qualified medical expense from the allowance amount and the plan design option.

37. A system for facilitating the delivery of marketing material to participants of a group benefits plan comprising:
a processor configured to:
receive data for a participant account in the group benefits plan, the data having a contact information, and
grant a third party vendor with limited access to the data for acquiring the contact information for delivery of the marketing material.

38. A system for modifying a participant's benefits plan, the system comprising:
a processor configured to:
receive an employer's selection of a group benefits plan from a client terminal, the group benefits plan excludes a Health Savings Account,
compute at least one option for compatibility with the Health Savings Account,
receive data for a participant account in the group benefits plan,
transmit the at least one option for compatibility with the Health Savings Account, and
receive a participant's election of one of the at least one option to modify the group benefits plan.

39. A system for modifying a participant's benefits plan, the system comprising:
a processor configured to:
receive an employer's selection of a group benefits plan from a client terminal, the group benefits plan includes a Health Savings Account (HSA),
compute at least one option for modifying the group benefits plan for HSA compatibility,
receive data for a participant account in the group benefits plan,
transmit the at least one option for modifying the group benefits plan, and
receive a participant's election of one of the at least one option to modify the participant's benefits plan for HSA compatibility.

40. A system for administering a benefits plan comprising:
a processor configured to:
receive a first data for a participant account in a benefits plan, the benefits plan selected from a group consisting of a Health Reimbursement Arrangement and a Flexible Spending Account,
receive a claim submission for the participant account,
transmit a query requesting proof of health insurance or proof of uninsurability,
receive a second data providing proof of health insurance or proof of uninsurability, and
compute reimbursement amount for the claim submission based on the received second data.

41. A system for accumulating a dollar allowance in a Health Reimbursement Arrangement, the system comprising:
a processor configured to:
receive an employer's selection of a dollar allowance per hour worked,
receive data for enrolling an employee in the Health Reimbursement Arrangement,
receive a number of hours worked by the employee in a predetermined period, and
compute the dollar allowance for the predetermined period to be accumulated in the employee's Health Reimbursement Arrangement by multiplying the employer's dollar allowance per hour worked with the employee's number of hours worked.
